(19) United States
(12) Patent Application Publication
(10) Pub. No.: US 2025/0076889 A1
(43) Pub. Date: Mar. 6, 2025

(54) INFORMATION PROCESSING DEVICE, INFORMATION PROCESSING METHOD, AND PROGRAM

(71) Applicant: SONY GROUP CORPORATION, TOKYO (JP)

(72) Inventor: KEIJI MURO, TOKYO (JP)

(21) Appl. No.: 18/551,520

(22) PCT Filed: Jan. 24, 2022
(86) PCT No.: PCT/JP2022/002358

§ 371 Date: Sep. 20, 2023

(30) Foreign Application Priority Data
Mar. 31, 2021 (JP) 2021-060123

(51) Int. Cl. G05D 1/622; G05D 1/246

(52) U.S. Cl. CPC G05D 1/622; G05D 1/2464

(57) ABSTRACT

There are provided a device and a method capable of reducing the processing load in the safety confirmation of the sub-goal and improving the possibility of detecting the safe traveling route. A sub-goal generation unit that generates a sub-goal pattern including a plurality of sub-goals in a traveling direction of a mobile object; and a sub-goal safety verification unit that performs safety verification as to whether or not the mobile object can safely travel, on each of the sub-goals constituting the sub-goal pattern are provided. The sub-goal generation unit generates a coarse sub-goal pattern having a wide sub-goal interval and a dense sub-goal pattern having a narrow sub-goal interval. The sub-goal safety verification unit performs the safety verification on the sub-goals of the coarse sub-goal pattern, and in a case where the sub-goal enabling the safe traveling is not detected, the sub-goal safety verification unit executes the safety verification on each of the sub-goals of the dense sub-goal pattern.

### TECHNICAL FIELD

The present disclosure relates to an information processing device, an information processing method, and a program. More specifically, the present disclosure relates to an information processing device, an information processing method, and a program which enable a mobile object such as an automated travel robot or an automated travel vehicle to travel safely.

### BACKGROUND ART

Recently, development and use of an automated traveling type robot and an automated traveling type vehicle have rapidly progressed. For example, development and use of various mobile objects such as a robot that travels in an unmanned manner while loading luggage in a warehouse or office, and an automated driving vehicle that travels on a road are in progress.

A mobile object such as an automated traveling type robot or an automated traveling type vehicle is required to travel safely while avoiding collision with another robot, another vehicle, a pedestrian, or the like.

Note that, for example, there are Patent Document 1 (Japanese Patent No. 5589762) and Patent Document 2 (Japanese Patent Application Laid-Open No. 2020-004342) as the techniques in the related art which disclose a safe traveling technique for an automated traveling type mobile object.

Patent Document 1 discloses a configuration for determining a traveling route of a mobile object while adjusting a distance between a side surface of the mobile object and a passage wall surface in a case where the mobile object travels on a passage. Specifically, by determining the traveling route on the basis of a shift amount of the mobile object from the wall surface, which is calculated at a position where the distance between the side surface of the mobile object and the passage wall surface is small, the traveling route that does not cause unnecessary meandering is determined.

Furthermore, Patent Document 2 discloses a configuration in which, for example, in a case where a mobile object passes through a narrow passage, a plurality of nodes through which the mobile object can pass are set, an edge that is a line segment connecting the nodes is generated, and a traveling route of the mobile object to pass through the edge is generated.

However, these techniques in the related art are intended only to safely pass through a narrow passage, and do not disclose, for example, a configuration in which a mobile object travels along a route as close as possible to a traveling route determined by a user in advance.

For example, even in the case of a passage, in an environment in which a plurality of mobile objects travels, it is necessary to take a measure such as setting to left-hand traffic in order for the plurality of mobile objects to travel safely. In such a case, the user needs to perform processing of setting a traveling route of the mobile object on the left side of the passage and causing the mobile object to travel.

That is, in order to safely travel in various traveling environments, it may be necessary to cause the mobile object to travel along a route set in advance by the user.

### CITATION LIST

### Patent Document

Patent Document 1: Japanese Patent No. 5589762
Patent Document 2: Japanese Patent Application Laid-Open No. 2020-004342

### SUMMARY OF THE INVENTION

### Problems to be Solved by the Invention

An object of the present disclosure is to provide an information processing device, an information processing method, and a program which cause a mobile object to travel along a safe route that is close to a traveling route set by a user in advance and does not collide with an obstacle.

An embodiment of the present disclosure provides an information processing device, an information processing method, and a program which realize safe traveling of a mobile object by configuring the mobile object to travel on a determined route while the mobile object sequentially determines a traveling route during the traveling.

### Solutions to Problems

A first aspect of the present disclosure is an information processing device including:
a sub-goal generation unit that generates a sub-goal pattern including a plurality of sub-goals in a traveling direction of a mobile object; and
a sub-goal safety verification unit that performs safety verification as to whether or not the mobile object can safely travel without colliding with or coming into contact with an obstacle, on each of the sub-goals constituting the sub-goal pattern generated by the sub-goal generation unit,
in which
the sub-goal generation unit generates a first sub-goal pattern and a second sub-goal pattern which have different sub-goal arrangement patterns, and
the sub-goal safety verification unit
   performs the safety verification on each of sub-goals included in the first sub-goal pattern, and
   executes the safety verification on each of sub-goals included in the second sub-goal pattern in a case where the sub-goal enabling safe traveling is not detected from the first sub-goal pattern.

Moreover, a second aspect of the present disclosure is an information processing method executed in an information processing device, the information processing method including:
a sub-goal generation step of generating a sub-goal pattern including a plurality of sub-goals in a traveling direction of a mobile object by a sub-goal generation unit; and
a sub-goal safety verification step of performing safety verification as to whether or not the mobile object can safely travel without colliding with or coming into contact with an obstacle, on each of the sub-goals constituting the sub-goal pattern generated by the sub-goal generation unit, by a sub-goal safety verification unit,
in which
the sub-goal generation step is a step of generating a first sub-goal pattern and a second sub-goal pattern which have different sub-goal arrangement patterns, and
the sub-goal safety verification step is a step of
   performing the safety verification on each of sub-goals included in the first sub-goal pattern, and
   executing the safety verification on each of sub-goals included in the second sub-goal pattern in a case where the sub-goal enabling safe traveling is not detected from the first sub-goal pattern.

Moreover, a third aspect of the present disclosure is a program causing an information processing device to execute information processing, the program causing:
a sub-goal generation unit to execute a sub-goal generation step of generating a sub-goal pattern including a plurality of sub-goals in a traveling direction of a mobile object; and
a sub-goal safety verification unit to execute a sub-goal safety verification step of performing safety verification as to whether or not the mobile object can safely travel without colliding with or coming into contact with an obstacle, on each of the sub-goals constituting the sub-goal pattern generated by the sub-goal generation unit,
in which
in the sub-goal generation step,
a first sub-goal pattern and a second sub-goal pattern which have different sub-goal arrangement patterns are generated, and
in the sub-goal safety verification step,
the safety verification is executed on each of sub-goals included in the first sub-goal pattern, and
the safety verification is executed on each of sub-goals included in the second sub-goal pattern in a case where the sub-goal enabling safe traveling is not detected from the first sub-goal pattern.

Note that the program of the present disclosure is, for example, a program that can be provided by a storage medium or a communication medium that provides various program codes in a computer-readable format, to an information processing device, an image processing device, or a computer system capable of executing the program codes. By providing such a program in a computer-readable format, processing corresponding to the program is implemented on the information processing device or the computer system.

Still other objects, features, and advantages of the present disclosure will become apparent from a more detailed description based on embodiments of the present disclosure as described later and the accompanying drawings. Note that, in the present specification, a system is a logical set configuration of a plurality of devices, and is not limited to a system in which devices of configurations are in the same housing.

With the configuration of the embodiment of the present disclosure, a device and a method capable of reducing the processing load in the safety confirmation of the sub-goal and improving the possibility of detecting the safe traveling route are realized.

Specifically, for example, a sub-goal generation unit that generates a sub-goal pattern including a plurality of sub-goals in the traveling direction of the mobile object, and a sub-goal safety verification unit that performs the safety verification on each of the sub-goals constituting the sub-goal pattern as to whether or not the mobile object can safely travel are included. The sub-goal generation unit generates a coarse sub-goal pattern having a wide sub-goal interval and a dense sub-goal pattern having a narrow sub-goal interval. The sub-goal safety verification unit performs the safety verification on the sub-goals of the coarse sub-goal pattern, and in a case where the sub-goal enabling the safe traveling is not detected, the sub-goal safety verification unit executes the safety verification on each of the sub-goals of the dense sub-goal pattern.

With the present configuration, a device and a method capable of reducing the processing load in the safety confirmation of the sub-goal and improving the possibility of detecting the safe traveling route are realized.

Note that the effects described in the present specification are only examples and are not limited thereto, and additional effects may also be present.

### BRIEF DESCRIPTION OF DRAWINGS

FIG. 1 is a diagram describing a traveling example of a mobile object along a user set route.

FIG. 2 is a diagram describing a traveling example of a mobile object along a user set route.

FIG. 3 is a diagram describing a traveling example of a mobile object along a user set route.

FIG. 4 is a diagram describing a traveling example of a mobile object along a user set route.

FIG. 5 is a diagram describing traveling control processing using a sub-goal.

FIG. 6 is a diagram describing a traveling control example of a mobile object in a case where a new obstacle that does not exist at the time of setting a user set route appears in front of the mobile object.

FIG. 7 is a diagram describing an example of generation processing of a new traveling route passing through a sub-goal SG2.

FIG. 8 is a flowchart describing a control sequence in a case where a traveling route is determined by safety determination processing using a sub-goal and safe traveling is performed.

FIG. 9 is a diagram describing an example in which a probability of determination that traveling is impossible is increased in a case where the number of sub-goals is reduced.

FIG. 10 is a diagram describing an example in which a probability of determination that traveling is impossible is increased in a case where the number of sub-goals is reduced.

FIG. 11 is a diagram describing an example of a plurality of sub-goal patterns set by a mobile object of the present disclosure.

FIG. 12 is a diagram describing a specific example of “the possibility that a safe traveling route can be detected is reduced” which is a disadvantage of a coarse sub-goal pattern.

FIG. 13 is a diagram illustrating a flowchart describing a processing sequence executed by the information processing device of the present disclosure.

FIG. 14 is a diagram illustrating a flowchart describing a processing sequence executed by the information processing device of the present disclosure.

FIG. 15 is a diagram describing specific examples of various sub-goal patterns.

FIG. 16 is a diagram describing specific examples of various sub-goal patterns.

FIG. 17 is a diagram describing specific examples of various sub-goal patterns.

FIG. 18 is a diagram describing specific examples of various sub-goal patterns.

FIG. 19 is a diagram describing specific examples of various sub-goal patterns.

FIG. 20 is a diagram describing specific examples of various sub-goal patterns.

FIG. 21 is a diagram describing specific examples of various sub-goal patterns.

FIG. 22 is a diagram describing a specific example of setting sub-goals using a user terminal capable of communicating with a mobile object.

FIG. 23 is a diagram describing a specific example of setting sub-goals using a user terminal capable of communicating with a mobile object.

FIG. 24 is a diagram describing a specific example of setting sub-goals using a user terminal capable of communicating with a mobile object.

FIG. 25 is a diagram describing a specific example of setting sub-goals using a user terminal capable of communicating with a mobile object.

FIG. 26 is a diagram describing a configuration example of the information processing device according to the present disclosure.

FIG. 27 is a diagram describing a configuration example of an information processing system of the present disclosure.

FIG. 28 is a diagram describing a hardware configuration example of the information processing device of the present disclosure.

### MODE FOR CARRYING OUT THE INVENTION

Hereinafter, an information processing device, information processing method, and program according to the present disclosure will be described in detail with reference to the drawings. Note that the description will be given according to the following items.
1. Regarding traveling of mobile object according to user set route and problems thereof
2. Regarding traveling control processing of mobile object using sub-goal
3. Regarding processing executed by information processing device of present disclosure
4. Regarding processing sequence executed by information processing device of present disclosure
5. Regarding example of setting sub-goal available for processing of present disclosure
6. Regarding user interface enabling processing such as sub-goal setting
7. Regarding configuration example of information processing device
8. Regarding configuration example of information processing system that performs processing by executing communication between mobile object and server
9. Regarding hardware configuration example of information processing device
10. Summary of configuration of present disclosure

### 1. Regarding Traveling of Mobile Object According to User Set Route and Problems Thereof

First, traveling of a mobile object according to a user set route and problems thereof will be described.

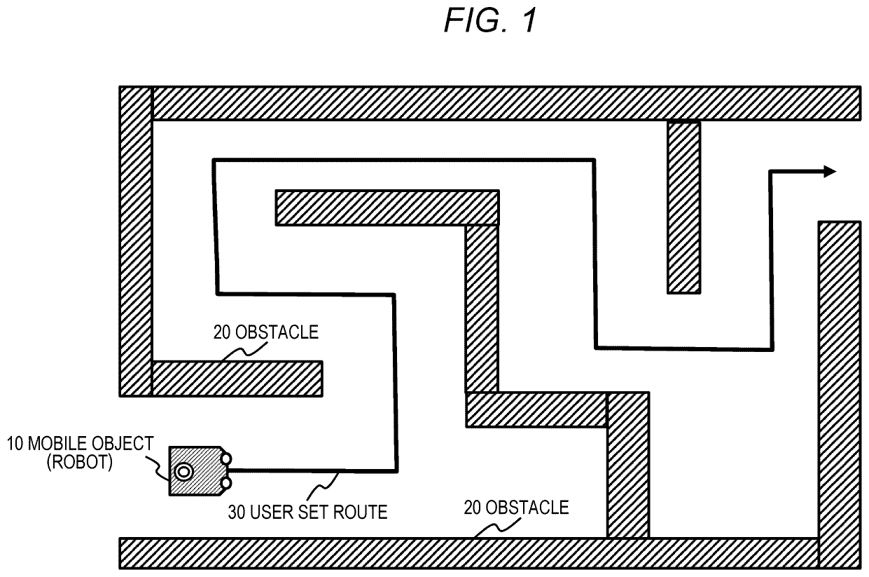

FIG. 1 is a diagram illustrating a traveling example of a mobile object (robot) 10. FIG. 1 illustrates an example in which the mobile object (robot) 10 travels on a traveling path on which an obstacle 20 such as a wall is present, along a user set route 30 (=global path).

The user set route 30 is a so-called global path, and is a traveling route determined by a user such as an operator by selecting a route that does not collide with or come into contact with the obstacle 20 such as a wall after confirming a traveling environment of the mobile object 10.

In a case where the user set route 30 is a route generated such that the mobile object 10 can travel away from the obstacle by a predetermined distance in consideration of the distance between the mobile object 10 and the obstacle 20, basically, the mobile object 10 can perform safe traveling by traveling along the user set route 30.

However, for example, after the user set route 30 is generated, a new obstacle may be arranged on the route.

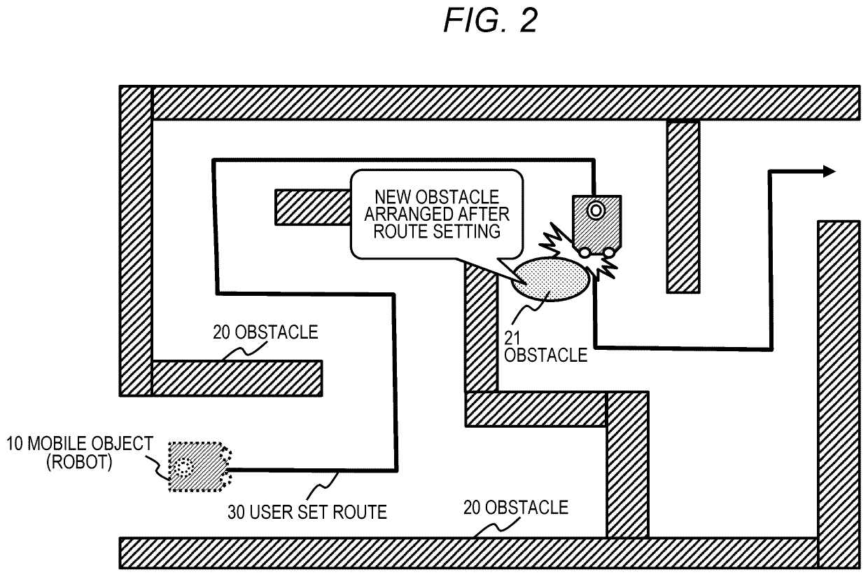

For example, as illustrated in FIG. 2, in a case where a new obstacle 21 is arranged, the mobile object 10 collides with the obstacle 21 even in a case where the mobile object 10 travels along the user set route 30.

Furthermore, for example, there may be a case where there is a problem in the user set route 30 itself, that is, there may be a case where the user set route 30 in which the mobile object 10 cannot travel away from the obstacle by a predetermined distance is set.

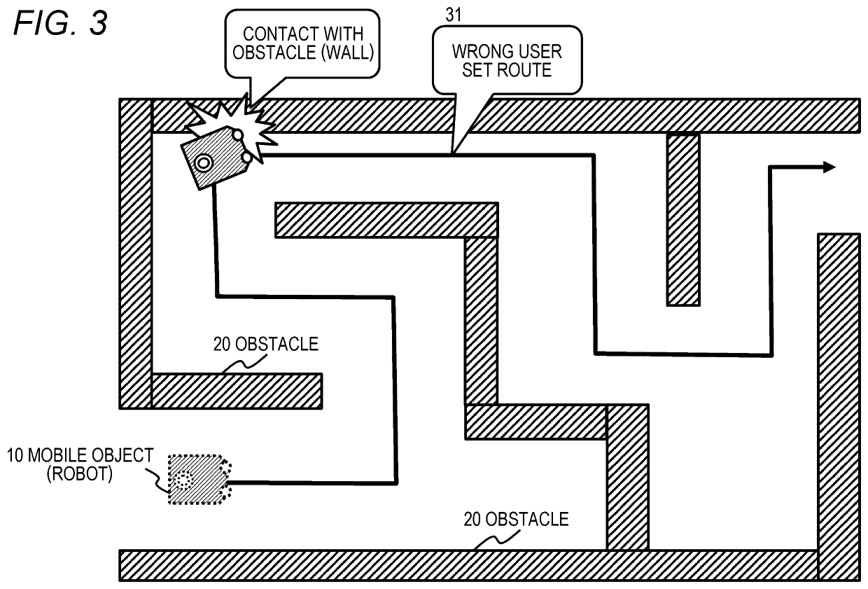

In this case, as illustrated in FIG. 3, even in a case where the mobile object 10 travels along the user set route 30, the mobile object 10 collides with or comes into contact with the obstacle 20 such as a wall.

Moreover, in a case where the traveling path of the mobile object 10 is an environment where other mobile objects, persons, and the like come and go, the mobile object 10 may collide with other mobile objects, persons, and the like even in a case where the mobile object 10 travels along the user set route 30.

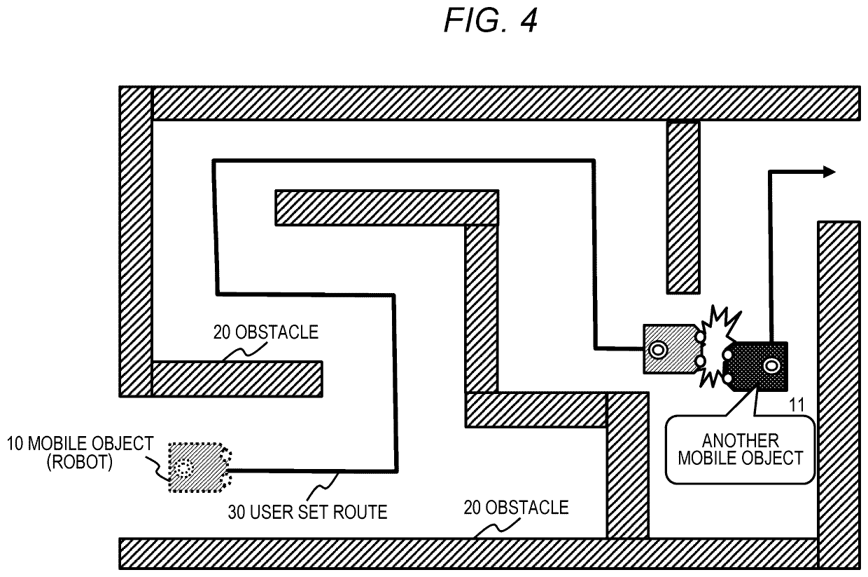

That is, as illustrated in FIG. 4, in a case where another mobile object 11 is traveling on the user set route 30, the mobile object 10 collides with the other mobile object 11 even in a case where the mobile object travels along the user set route 30.

In order for the mobile object 10 to travel safely without causing collision or contact with an obstacle, another mobile object, a person, or the like as described above, it is necessary for the mobile object 10 to travel by confirming a traveling direction during the traveling and sequentially selecting a safe traveling route.

As traveling control processing of performing the safe traveling, there is traveling control processing using a sub-goal.

Hereinafter, the traveling control processing using a sub-goal will be described.

### 2. Regarding Traveling Control Processing of Mobile Object Using Sub-Goal

Next, the traveling control processing of the mobile object using the sub-goal will be described.

As described above, in order for the mobile object 10 to travel safely without causing collision or contact with an obstacle, another mobile object, a person, or the like as described above, it is necessary for the mobile object 10 to travel by confirming a traveling direction during the traveling and sequentially selecting a safe traveling route.

An example of the traveling control processing of performing the safe traveling is traveling control processing using a sub-goal.

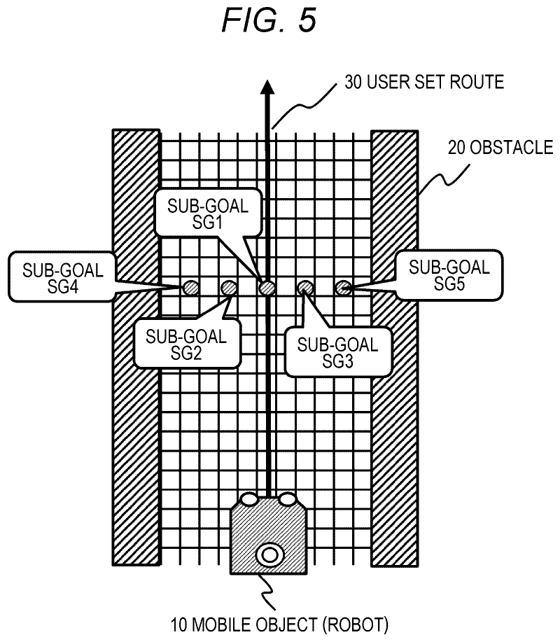

The traveling control processing using the sub-goal will be described with reference to FIG. 5 and subsequent drawings.

FIG. 5 illustrates the mobile object (robot) 10 traveling along the user set route 30 set in advance.

The mobile object 10 travels while detecting the position of an obstacle ahead using a sensor such as a camera or light detection and ranging (LiDAR).

Basically, the vehicle travels along the user set route 30 set in advance, but in a case where it is determined that the mobile object cannot travel along the user set route 30 on the basis of sensor acquisition information, the mobile object changes the traveling route, sets a new traveling route, and travels.

The mobile object 10 changes the traveling route in a case where it is determined that the mobile object 10 cannot travel along the user set route 30. That is, this is a case where it is determined that there is a risk of collision or contact with an obstacle when the mobile object travels along the user set route 30.

In this case, the mobile object 10 sets a new route that allows safe traveling, and travels along the new route. However, the new route to be set is set to a position as close as possible to the user set route 30.

The sub-goal is used to detect this safe new traveling route.

FIG. 5 illustrates an example in which five sub-goals (SG1 to SG5) are set at positions ahead by a certain distance in the traveling direction of the mobile object 10.

The mobile object 10 analyzes whether or not each of the routes passing through the five sub-goals (SG1 to SG5) is a route that does not collide with or come into contact with an obstacle individually.

Note that the grid illustrated in FIG. 5 indicates a grid set in an occupancy grid map (grid map) which is a map generated by the mobile object 10.

The occupancy grid map (grid map) is a map in which a probability value of presence of an obstacle in each section (grid) defined by the grid is set.

The mobile object 10 can travel safely without colliding with an obstacle by selecting, as a traveling route, a section (grid) in which the probability of the presence of an obstacle is low, among sections of the occupancy grid map (grid map), and traveling.

In a case where the traveling control using the sub-goal is performed, the mobile object 10 sets a plurality of sub-goals in front of the mob in the traveling direction, and performs safety evaluation for each of the set sub-goals to determine the traveling route.

For example, it is analyzed whether or not each of the routes passing through the five sub-goals (SG1 to SG5) illustrated in FIG. 5 is a route that does not collide with or come into contact with an obstacle individually.

The mobile object 10 first analyzes whether or not the sub-goal SG1 at the position closest to the user set route 30 set in advance is a route that does not collide with or come into contact with an obstacle.

The mobile object 10 detects the position of an obstacle ahead using a sensor such as a camera or light detection and ranging (LiDAR), and further analyzes whether or not the mobile object 10 collides with or comes into contact with the obstacle in a case where the mobile object 10 travels along a route in which the center of the mobile object 10 passes through the sub-goal position for the sub-goal SG1 at the position closest to the user set route 30 in consideration of the size of the mobile object 10.

In a case where it is determined that the route passing through the sub-goal SG1 is a safe traveling route that does not collide with or come into contact with an obstacle, the route passing through the sub-goal SG1 is determined as the traveling route, and traveling is performed.

In this case, the safety determination processing for the other sub-goals (SG2 to SG5) is not performed.

However, in a case where it is determined that the route passing through the sub-goal SG1 is a dangerous traveling route that collides with or comes into contact with an obstacle, the mobile object 10 determines the safety of the route passing through the sub-goal SG2 close to the user set route 30 next.

In a case where it is determined that the route passing through the sub-goal SG2 is a safe traveling route that does not collide with or come into contact with an obstacle, a new traveling route passing through the sub-goal SG2 is generated, and the mobile object 10 travels along the generated new traveling route.

In this case, the traveling route of the mobile object 10 is a traveling route shifted from the user set route 30.

Note that in a case where it is also determined that the route passing through the sub-goal SG2 is a dangerous traveling route that collides with or comes into contact with an obstacle, the mobile object 10 determines the safety of the route passing through the sub-goal SG3 close to the user set route 30 next.

As described above, for each of the routes passing through the five sub-goals (SG1 to SG5), the mobile object 10 executes safety evaluation as to whether or not the routes are routes that do not collide with or come into contact with an obstacle individually in the order of the proximity to the user set route 30.

In a case where a route including the sub-goal that does not collide with or come into contact with an obstacle is detected, the safety evaluation for other sub-goals can be omitted.

Note that the distances between the mobile object 10 illustrated in FIG. 5 and the five sub-goals (SG1 to SG5) illustrated in FIG. 5 are set to a distance at which the mobile object 10 can travel along a safe traveling route passing through the selected sub-goal.

For the sub-goals (SG1 to SG5) illustrated in FIG. 5, in a case where one sub-goal that enables safe traveling is selected, a traveling route passing through the sub-goal is determined, and the mobile object starts traveling along the traveling route, then, next, the mobile object 10 sets a new sub-goal row, that is, a sub-goal row including five sub-goals (SG1 to SG5), at a position further ahead of the sub-goal row of which safety verification has been completed.

Moreover, similar safety determination is performed for each of the five sub-goals (SG1 to SG5) constituting the new sub-goal row, a traveling route including a safe sub-goal is determined, and traveling is performed.

In this manner, the mobile object 10 sets a plurality of sub-goals at positions separated by a certain distance in the traveling direction of the mobile object 10, performs the safety evaluation of a route passing through each sub-goal, and travels while selecting a route passing through the sub-goal that enables safe traveling.

By performing such traveling control, it is possible to perform safe traveling corresponding to sudden appearance of an obstacle or the like while selecting a route closer to the user set route 30 set in advance.

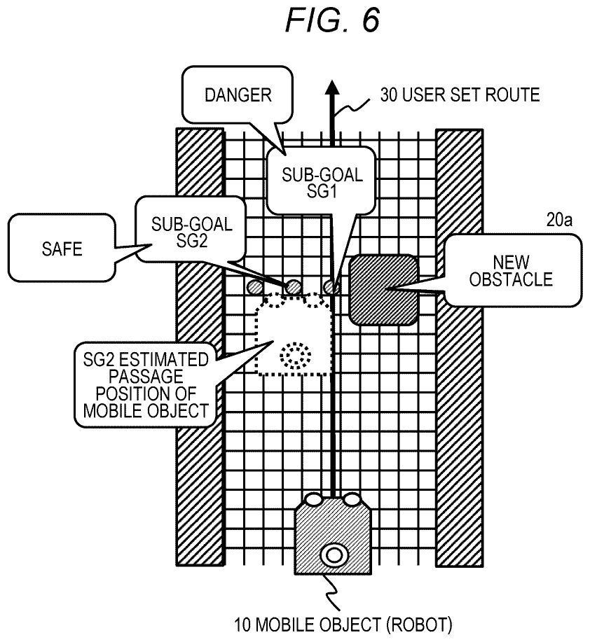

FIG. 6 is a diagram describing a traveling control example of the mobile object 10 in a case where a new obstacle 20a that does not exist at the time of setting the user set route 30 appears in front of the mobile object 10.

The mobile object 10 first analyzes whether or not the sub-goal SG1 at the position closest to the user set route 30 set in advance is a route that does not collide with or come into contact with an obstacle.

The mobile object 10 detects the position of an obstacle ahead using a sensor such as a camera or light detection and ranging (LiDAR), and further analyzes whether or not the sub-goal SG1 at the position closest to the user set route 30 is a route that does not collide with or come into contact with the obstacle in consideration of the size of the mobile object 10.

In the example illustrated in FIG. 6, it is determined that the route passing through the sub-goal SG1 is a dangerous traveling route that collides with a new obstacle 20a.

In this case, the mobile object 10 determines the safety of the route passing through the sub-goal SG2 close to the user set route 30 next.

As illustrated in FIG. 6, it is determined that the route passing through the sub-goal SG2 is a safe traveling route that does not collide with or come into contact with the new obstacle 20a or the side wall.

In FIG. 6, a sub-goal (SG2) estimated passage position of the mobile object 10 is indicated by a dotted line.

As described above, as understood from the sub-goal (SG2) estimated passage position of the mobile object 10, a sub-goal SG2 passage route of the mobile object 10 is a safe traveling route that does not collide with or come into contact with the new obstacle 20a or the side wall.

In accordance with this determination, the mobile object 10 generates a new traveling route passing through the sub-goal SG2.

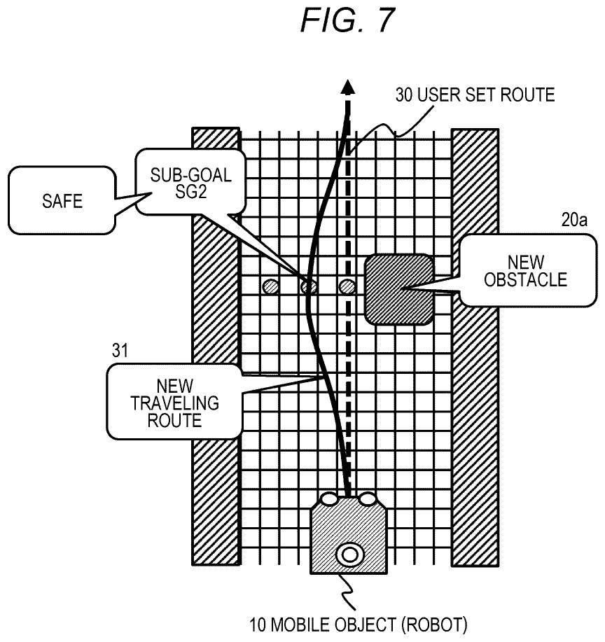

That is, as illustrated in FIG. 7, a new traveling route 31 passing through the sub-goal SG2 is generated.

The mobile object 10 travels along the generated new traveling route 31.

In this case, the traveling route of the mobile object 10 is a traveling route shifted from the user set route 30, but it is possible to travel safely without colliding with an obstacle.

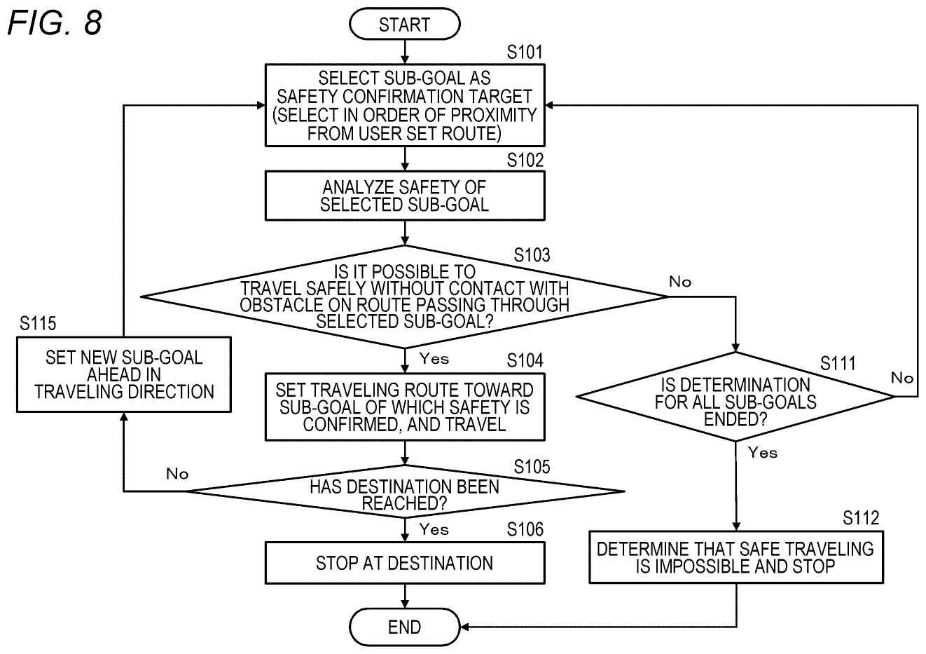

Next, a control sequence in a case where a traveling route is determined by the safety determination processing using the sub-goal and safe traveling is performed will be described with reference to FIG. 8.

The flowchart illustrated in FIG. 8 is a flowchart for describing a traveling control sequence in which the mobile object 10 executes safety determination for a plurality of sub-goals set in the traveling direction of the mobile object, determines a traveling route on the basis of a determination result, and performs safe traveling along the determined route.

The processing according to this flow can be executed, for example, by a control unit (data processing unit) of the mobile object 10 according to a program stored in a storage unit. For example, the processing can be executed as program execution processing by a processor such as a CPU having a program execution function.

Hereinafter, processing of respective steps of the flow illustrated in FIG. 8 will be described.

### (Step S101)

First, in step S101, the mobile object 10 selects one sub-goal as a target of safety confirmation processing, from the plurality of sub-goals set in the traveling direction of the mobile object 10.

Note that the sub-goals as the safety confirmation targets are sequentially selected, for example, in the order of proximity from the user set route.

### (Step S102)

Next, in step S102, the mobile object 10 confirms the safety of one sub-goal as the safety confirmation processing target selected in step S101.

As described above, this safety confirmation processing is executed as confirmation processing as to whether or not the route is a route that does not collide with or come into contact with an obstacle.

That is, the mobile object 10 detects the position of an obstacle ahead using a sensor such as a camera or light detection and ranging (LiDAR), and determines the safety of the selected sub-goal as the target of the safety determination processing in consideration of the size of the mobile object 10. Specifically, it is analyzed whether or not the mobile object 10 collides with or comes into contact with an obstacle in a case where the mobile object 10 travels along a route in which the center of the mobile object 10 passes through the selected sub-goal position.

### (Step S103)

Next, in step S103, the mobile object 10 determines whether or not the safety of the sub-goal on which the safety determination processing has been performed in step S102 is confirmed.

In a case where the safety of the selected sub-goal is confirmed, that is, in a case where it is confirmed that the mobile object 10 does not collide with or come into contact with an obstacle in a case where the mobile object 10 travels along a route in which the center of the mobile object 10 passes through the selected sub-goal, the processing proceeds to step S104.

On the other hand, in a case where the safety of the selected sub-goal is not confirmed, that is, in a case where it is confirmed the possibility that the mobile object 10 collides with or comes into contact with an obstacle in a case where the mobile object 10 travels along a route in which the center of the mobile object 10 passes through the selected sub-goal, the processing proceeds to step S111.

### (Step S111)

In step S103, in a case where the safety of the selected sub-goal on which the safety confirmation has been performed is not confirmed, the processing proceeds to step S111.

In this case, in step S111, the mobile object 10 first determines whether or not the safety confirmation for all the set sub-goals is ended.

In a case where the safety confirmation for all the set sub-goals is not ended, the processing returns to step S111, one sub-goal of which the safety has not been confirmed is selected, and the safety confirmation processing is executed for the selected sub-goal in step S102 and subsequent steps.

In a case where it is determined in step S111 that the safety confirmation for all the set sub-goals is ended, the processing proceeds to step S112.

### (Step S112)

The processing of step S112 is processing executed in a case where it is determined in step S111 that the safety confirmation for all the set sub-goals is ended.

In this case, in step S112, the mobile object 10 determines that safe traveling of the mobile object 10 is impossible, and executes processing of stopping.

### (Step S104)

Next, the processing in a case where the safety of the selected sub-goal on which the safety confirmation has been performed is confirmed in step S103 will be described with reference to step S104 and subsequent steps.

In step S103, in a case where the safety of the selected sub-goal on which the safety confirmation has been performed is confirmed, the processing proceeds to step S104.

In this case, in step S104, the mobile object 10 sets a traveling route toward the sub-goal of which the safety has been confirmed, and travels.

### (Step S105)

Next, in step S105, the mobile object 10 determines whether or not the mobile object 10 has reached the destination.

In a case where it is determined that the mobile object 10 has reached the destination, the processing proceeds to step S106.

On the other hand, in a case where it is determined that the mobile object 10 has not reached the destination, the processing proceeds to step S115.

### (Step S106)

In a case where it is determined in step S105 that the mobile object 10 has reached the destination, the mobile object 10 stops and ends the traveling in step S106.

### (Step S115)

On the other hand, in a case where it is determined in step S105 that the mobile object 10 has not reached the destination, in step S115, the mobile object 10 sets a new sub-goal ahead in the traveling direction of the mobile object 10, and executes the processing of step S101 and subsequent steps for the set new sub-goal.

In this manner, the mobile object 10 sets a plurality of sub-goals at positions separated by a certain distance in the traveling direction of the mobile object 10, performs the safety evaluation of a route passing through each sub-goal, and travels while selecting a route passing through the sub-goal that enables safe traveling.

By performing such traveling control, it is possible to perform safe traveling corresponding to sudden appearance of an obstacle or the like while selecting a route closer to the user set route 30 set in advance.

However, as a problem of the traveling control processing using the sub-goal, there is a problem that the processing load of the safety confirmation processing of each sub-goal is large.

For example, as illustrated in FIG. 5, in a case where five sub-goals (SG1 to SG5) are set and safety confirmation is sequentially performed for each sub-goal in the order of proximity from the user set route 30, it is necessary to perform safety confirmation up to five times. Until the safety confirmation is ended, the mobile object 10 cannot determine the traveling route, and as a result, the traveling speed of the mobile object 10 may be decreased.

Note that it is possible to reduce the processing load of the sub-goal safety determination processing in a case where the number of sub-goals as the target of the safety confirmation processing is reduced, but there is a problem that it is difficult to control a detailed traveling route in a case where the number of sub-goals is reduced, and the probability that it is determined that traveling is impossible is increased.

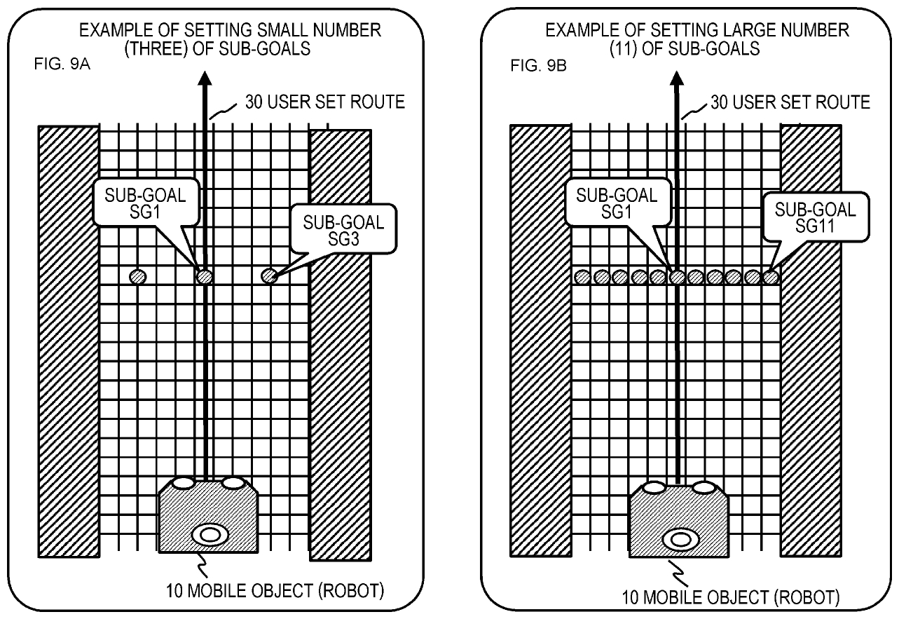

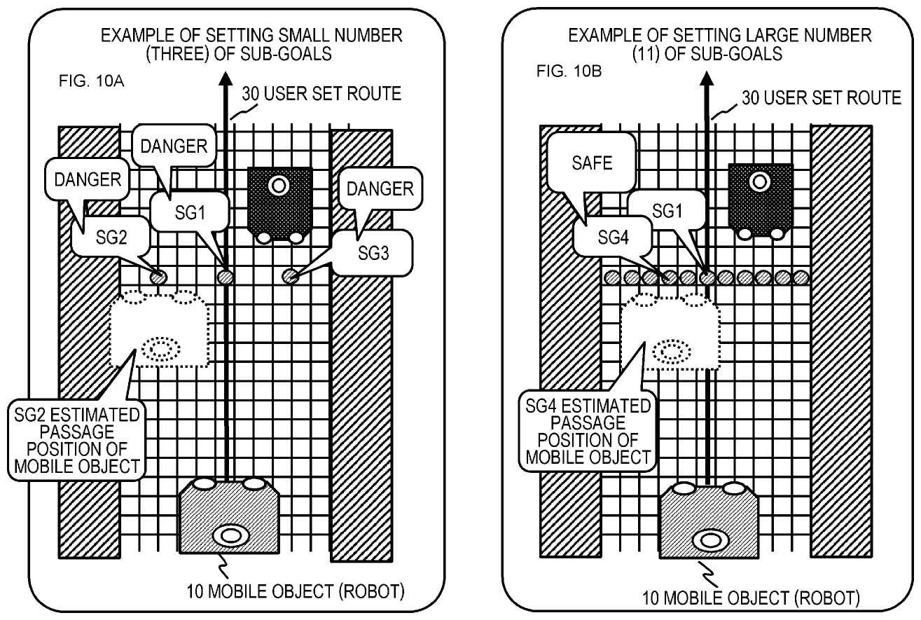

A specific example of this will be described with reference to FIGS. 9 and 10.

FIG. 9 illustrates the following two different examples of setting the sub-goal.
(A) Example of setting small number (three) of sub-goals
(B) Example of setting large number (11) of sub-goals

In the setting in the (A) example of setting a small number (three) of sub-goals, the mobile object 10 sequentially executes the safety evaluation for the three sub-goals (SG1 to SG3) in the order of proximity to the user set route 30.

On the other hand, in the setting in the (B) example of setting a large number (11) of sub-goals, the mobile object 10 sequentially executes the safety evaluation for the 11 sub-goals (SG1 to SG11) in the order of proximity to the user set route 30.

Note that, in any case, in a case where a sub-goal enabling the safe traveling is detected, the safety confirmation processing of the sub-goal is ended at that time, and the safety confirmation for other sub-goals is not performed.

In this setting, for example, as illustrated in FIG. 10, it is assumed that another mobile object as an obstacle is approaching ahead.

In the (A) example of setting a small number (three) of sub-goals, the mobile object 10 sequentially executes the safety evaluation for the three sub-goals (SG1 to SG3) in the order of proximity to the user set route 30, but there is a possibility that all of the three sub-goals (SG1 to SG3) come into contact with any obstacle such as another mobile object or a side wall.

In this case, the mobile object 10 cannot detect a safe sub-goal passage route. As a result, the mobile object 10 stops.

On the other hand, in the (B) example of setting a large number (11) of sub-goals, the mobile object 10 sequentially executes the safety evaluation for the 11 sub-goals (SG1 to SG11) in the order of proximity to the user set route 30, and it is confirmed that the sub-goal SG4, which is the fourth safety confirmation target sub-goal, is a sub-goal that can secure a safe traveling route with no possibility of contacting with an obstacle such as another mobile object or a side wall.

As a result, the mobile object 10 can set a route passing through the safe sub-goal SG4 as a new traveling route, and travel along the new traveling route.

In this way, in a case where the number of sub-goals is increased, a detailed traveling route can be set.

On the other hand, in a case where the number of sub-goals is reduced as illustrated in FIG. 10(A), a detailed traveling route cannot be set, the probability that it is determined that traveling is impossible is increased, and a problem that smooth traveling of the mobile object 10 is hindered occurs.

However, on the other hand, in a case where the number of sub-goals to be set is increased, the processing load of the sub-goal safety determination processing is increased, and a problem that the traveling speed of the mobile object 10 is reduced occurs.

The present disclosure solves these problems, and changes a sub-goal pattern to be set according to a situation to realize efficient safe traveling of the mobile object.

Hereinafter, a specific example of the processing of the present disclosure will be described.

### 3. Regarding Processing Executed by Information Processing Device of Present Disclosure

Hereinafter, the processing executed by the information processing device of the present disclosure will be described.

Note that the information processing device of the present disclosure is configured inside the mobile object 10, for example. Note that the data processing unit other than the sensor unit and the drive unit may be provided in an external device such as a server that can communicate with the mobile object 10.

The information processing device of the present disclosure, for example, the mobile object 10 changes the sub-goal pattern set ahead in the traveling path of the mobile object according to the situation, and efficiently realizes the safe traveling of the mobile object 10.

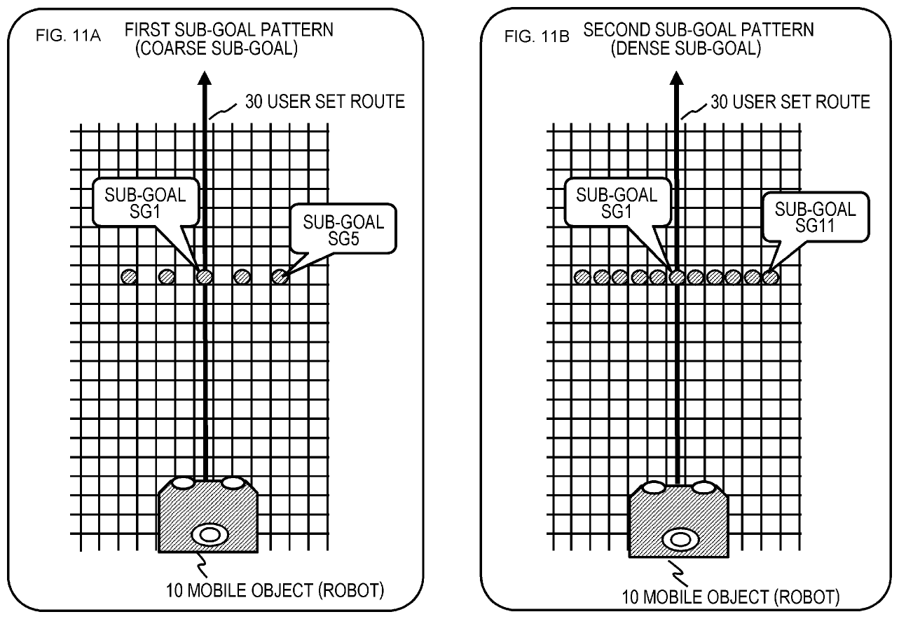

FIG. 11 illustrates an example of a plurality of sub-goal patterns set by the mobile object 10 of the present disclosure.

FIG. 11 illustrates the following two types of sub-goal patterns set by the mobile object 10 of the present disclosure.
(A) First sub-goal pattern (coarse sub-goal pattern)
(B) Second sub-goal pattern (dense sub-goal pattern)

As illustrated in FIG. 11, the (A) first sub-goal pattern (coarse sub-goal pattern) is a sub-goal pattern in which five sub-goals (SG1 to SG5) are set on a line separated by a certain distance, in the traveling direction of the mobile object 10.

On the other hand, the (B) second sub-goal pattern (dense sub-goal pattern) is a sub-goal pattern in which 11 sub-goals (SG1 to SG11) are set on a line separated by a certain distance, in the traveling direction of the mobile object 10.

The (A) first sub-goal pattern (coarse sub-goal pattern) is a pattern in which the interval between individual sub-goals is wide, that is, a sub-goal pattern in which the distance between adjacent sub-goals is large.

On the other hand, the (B) second sub-goal pattern (dense sub-goal pattern) is a pattern in which the interval between individual sub-goals is narrow, that is, a sub-goal pattern in which the distance between adjacent sub-goals is small.

Note that the two types of sub-goal patterns illustrated in FIG. 11 are merely an example, and the information processing device of the present disclosure, for example, the mobile object 10 can set and use sub-goal patterns with various different settings in addition to this.

Other examples of the sub-goal pattern will be described later.

For example, the mobile object 10 of the present disclosure changes the two types of sub-goal patterns illustrated in FIG. 11 according to the situation, so that it is possible to efficiently detect the optimal traveling route without excessively increasing the processing load of the safety confirmation processing of the sub-goal in the mobile object 10.

Note that advantages and disadvantages of the two sub-goal patterns illustrated in FIG. 11 are as follows.
(A) First sub-goal pattern (coarse sub-goal pattern)
Advantages=the processing load of the safety confirmation processing of the sub-goal is reduced.
Disadvantages=since the number of sub-goals as the safety confirmation target is small, the possibility that a safe traveling route can be detected is reduced.
(B) Second sub-goal pattern (dense sub-goal pattern)
Advantages=Since the number of sub-goals as the safety confirmation target is large, the possibility that a safe traveling route can be detected is improved.
Disadvantages=Since the number of sub-goals as the safety confirmation target is large, the processing load of the safety confirmation processing of the sub-goal is increased.

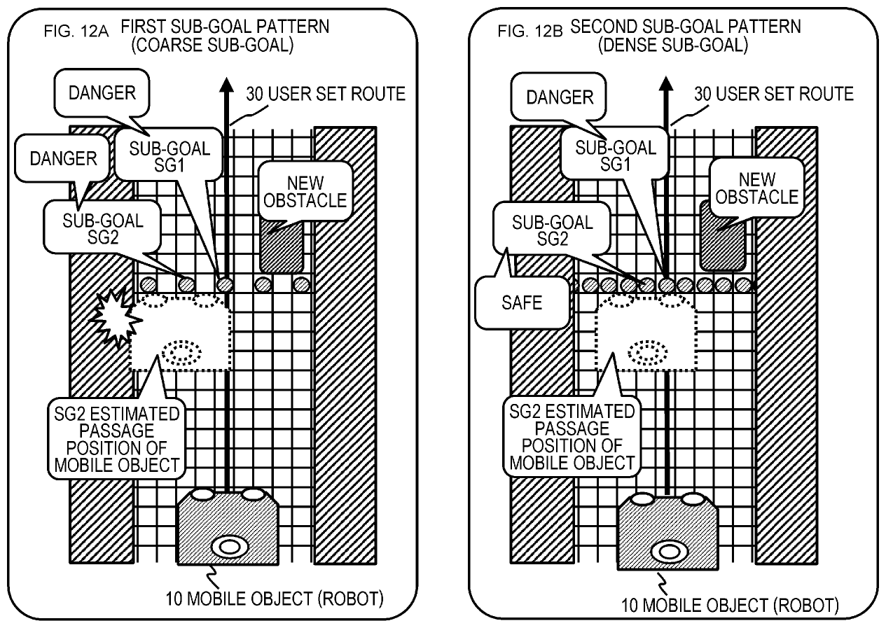

FIG. 12 is a diagram illustrating a specific example of “the possibility that a safe traveling route can be detected is reduced” which is a disadvantage of the (A) first sub-goal pattern (coarse sub-goal pattern).

This figure is a diagram describing a situation similar to that described above with reference to FIG. 10.

As illustrated in FIG. 12, it is assumed that a new obstacle is installed in front of the mobile object 10.

In a case where the (A) first sub-goal pattern (coarse sub-goal pattern) is used, the mobile object 10 sequentially executes the safety evaluation for the five sub-goals (SG1 to SG5) in the order of proximity to the user set route 30, but there is a possibility that all of the five sub-goals (SG1 to SG5) come into contact with any obstacle such as a new obstacle or a side wall.

In this case, the mobile object 10 cannot detect a safe sub-goal passage route. As a result, the mobile object 10 stops.

On the other hand, in a case where the (B) second sub-goal pattern (dense sub-goal pattern) is used, the mobile object 10 sequentially executes the safety evaluation for a large number of sub-goals (SG1 to SG11) in the order of proximity to the user set route 30. In the safety confirmation processing of the sub-goal SG2 that is the second safety confirmation target sub-goal, the mobile object 10 can confirm that the SG2 is a sub-goal that can secure a safe traveling route with no possibility of contacting with an obstacle such as a new obstacle or a side wall.

As a result, the mobile object 10 can set a route passing through the safe sub-goal SG2 as a new traveling route, and travel along the new traveling route.

As described above, the possibility that a safe traveling route can be detected can be increased in a case where the “(B) second sub-goal pattern (dense sub-goal pattern)” is set rather than in a case where the “(A) first sub-goal pattern (coarse sub-goal pattern)” is set.

However, as described above, in a case where the “(B) second sub-goal pattern (dense sub-goal pattern)” is set, a problem that the processing load of the safety confirmation processing of the sub-goal is increased occurs.

Therefore, the information processing device of the present disclosure, for example, the mobile object 10 sets and uses the “(A) first sub-goal pattern (coarse sub-goal pattern)” as a basic sub-goal pattern. Moreover, only in a case where a safe traveling route cannot be detected on the basis of the “(A) first sub-goal pattern (coarse sub-goal pattern)”, the “(B) second sub-goal pattern (dense sub-goal pattern)” is set and used.

### 4. Regarding Processing Sequence Executed by Information Processing Device of Present Disclosure

Next, the processing sequence executed by the information processing device of the present disclosure will be described.

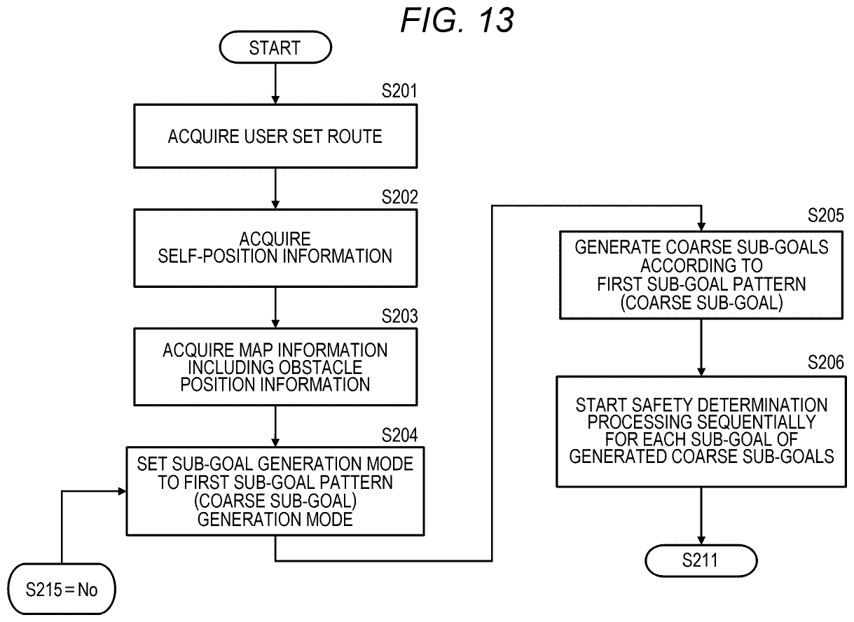

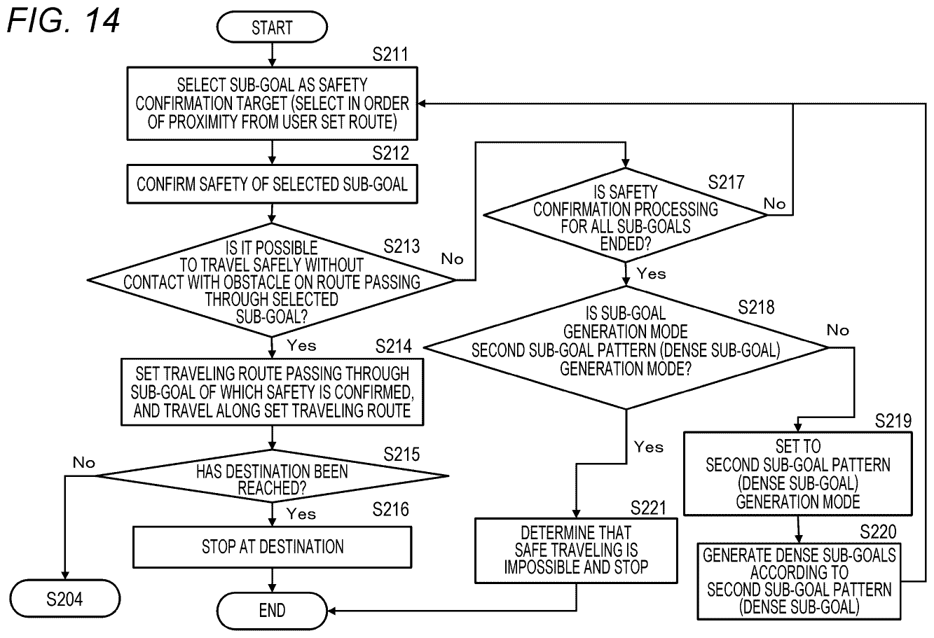

FIGS. 13 and 14 are flowcharts describing a processing sequence executed by the information processing device of the present disclosure, for example, the mobile object 10.

The processing according to this flowchart illustrated in FIGS. 13 and 14 can be executed, for example, by a control unit (data processing unit) of the mobile object 10 according to a program stored in a storage unit. For example, the processing can be executed as program execution processing by a processor such as a CPU having a program execution function.

Hereinafter, the processing of respective steps of the flow illustrated in FIGS. 13 and 14 will be described.

### (Step S201)

First, in step S201, the information processing device of the present disclosure, for example, the data processing unit of the mobile object 10 acquires the user set route. The user set route is stored in advance in the storage unit inside the mobile object 10, for example.

Alternatively, the user set route may be stored in an external device such as a server that can communicate with the mobile object 10, and the data may be acquired.

### (Steps S202 and S203)

Next, in steps S202 and S203, the data processing unit of the mobile object 10 executes processing of estimating the current position of the mobile object, that is, self-position estimation processing to acquire self-position information, and further acquires map information including obstacle position information around the mobile object 10.

The self-position estimation processing and the map generation processing are executed by simultaneous localization and mapping (SLAM), for example.

SLAM is processing of executing self-position estimation processing (localization) and environmental map creation processing (mapping) in parallel using, for example, sensor acquisition information by a camera and the like, for example, an image captured by a camera mounted on the mobile object 10.

For example, by analyzing the trajectory of feature points included in the image captured by the camera mounted on the mobile object 10, the three-dimensional position of the feature points is estimated, and a map, a so-called environmental map, capable of understanding the object position and the like around the mobile object is created (mapping). Moreover, the self-position (position of the mobile object 10) is also estimated (localization).

By the SLAM processing, various object positions around the mobile object are analyzed, and the environmental map can be created by integrating the analyzed object positions.

As described above, the processing of executing the self-position estimation processing (localization) and the environmental map creation processing (mapping) in parallel using the sensor acquisition information by the camera and the like is SLAM.

SLAM is not limited to visual SLAM using the camera-captured image described above, and there are various methods. For example, there is light detection and ranging (LiDAR) SLAM performed using LiDAR which is a sensor that measures a distance to an obstacle by laser light.

In steps S202 and S203, for example, by the SLAM processing, self-position information that is the current position of the mobile object 10 is acquired, and map information including obstacle position information around the mobile object 10 is further generated.

### (Step S204)

Next, in step S204, the data processing unit of the mobile object 10 sets a sub-goal generation mode to the “first sub-goal pattern (coarse sub-goal pattern) generation mode”.

That is, for example, the sub-goal generation mode is set to a generation mode of the pattern described above with reference to FIG. 11(A), that is, the “(A) first sub-goal pattern (coarse sub-goal pattern)”.

The “(A) first sub-goal pattern (coarse sub-goal pattern)” is a pattern in which the interval between individual sub-goals is wide, that is, a sub-goal pattern in which the distance between adjacent sub-goals is large.

### (Step S205)

Next, in step S205, the data processing unit of the mobile object 10 generates sub-goals (coarse sub-goals) according to the first sub-goal pattern (coarse sub-goal pattern).

That is, the mobile object 10 sets a coarse sub-goal pattern in which the interval between individual sub-goals is wide, at the position separated by a certain distance in the traveling direction of the mobile object 10.

Specifically, for example, a coarse sub-goal pattern according to the “(A) first sub-goal pattern (coarse sub-goal pattern)” described above with reference to FIG. 11 is generated.

### (Step S206)

Next, in step S206, the data processing unit of the mobile object 10 sequentially starts the safety confirmation processing for each sub-goal of the coarse sub-goal pattern generated in step S205.

As described above, the safety confirmation processing for the sub-goal is processing of confirming whether or not a route in which the center of the mobile object 10 passes through each sub-goal is a route that does not collide with or come into contact with an obstacle, for each sub-goal of the generated coarse sub-goal pattern.

The safety confirmation processing for the sub-goal is executed after the following step S211.

### (Step S211)

First, in step S211, the data processing unit of the mobile object 10 selects one sub-goal as a target of safety confirmation processing, from the plurality of sub-goals set in the traveling direction of the mobile object 10.

Note that the sub-goal set at the initial stage is a coarse sub-goal pattern with a wide sub-goal interval.

The sub-goals as the safety confirmation targets are sequentially selected, for example, in the order of proximity from the user set route.

### (Step S212)

Next, in step S212, the data processing unit of the mobile object 10 confirms the safety of one sub-goal as the safety confirmation processing target selected in step S211.

As described above, this safety confirmation processing is executed as confirmation processing as to whether or not the route is a route that does not collide with or come into contact with an obstacle.

The mobile object 10 detects the position of an obstacle ahead using a sensor such as a camera or light detection and ranging (LiDAR), and determines the safety of the selected sub-goal as the target of the safety determination processing in consideration of the size of the mobile object 10. Specifically, it is analyzed whether or not the mobile object 10 collides with or comes into contact with an obstacle in a case where the mobile object 10 travels along a route in which the center of the mobile object 10 passes through the selected sub-goal position.

### (Step S213)

Next, in step S213, the mobile object 10 determines whether or not the safety of the sub-goal on which the safety determination processing has been performed in step S212 is confirmed.

In a case where the safety of the selected sub-goal is confirmed, that is, in a case where it is confirmed that the mobile object 10 does not collide with or come into contact with an obstacle in a case where the mobile object 10 travels along a route in which the center of the mobile object 10 passes through the selected sub-goal, the processing proceeds to step S214.

On the other hand, in a case where the safety of the selected sub-goal is not confirmed, that is, in a case where it is confirmed the possibility that the mobile object 10 collides with or comes into contact with an obstacle in a case where the mobile object 10 travels along a route in which the center of the mobile object 10 passes through the selected sub-goal, the processing proceeds to step S217.

### (Step S214)

the processing in a case where the safety of the selected sub-goal on which the safety confirmation has been performed is confirmed in step S213 will be described with reference to step S214 and subsequent steps.

In step S213, in a case where the safety of the selected sub-goal on which the safety confirmation has been performed is confirmed, the processing proceeds to step S214.

In this case, in step S214, the mobile object 10 sets a traveling route toward the sub-goal of which the safety has been confirmed, and travels.

### (Step S215)

Next, in step S215, the mobile object 10 determines whether or not the mobile object 10 has reached the destination.

In a case where it is determined that the mobile object 10 has reached the destination, the processing proceeds to step S216.

On the other hand, in a case where it is determined that the mobile object 10 has not reached the destination, the processing returns to step S204.

### (Step S216)

In a case where it is determined in step S215 that the mobile object 10 has reached the destination, the mobile object 10 stops and ends the traveling in step S216.

Note that in a case where it is determined in step S215 that the mobile object 10 has not reached the destination, the processing returns to step S204, and the processing of step S204 and subsequent steps is repeated.

That is, in step S204, the data processing unit of the mobile object 10 sets a sub-goal generation mode to the “first sub-goal pattern (coarse sub-goal pattern) generation mode”.

Thereafter, in step S205, according to the “first sub-goal pattern (coarse sub-goal pattern) generation mode”, a new coarse sub-goal pattern is set at the position ahead of the processed sub-goal, that is, the position ahead of the mobile object 10 in the traveling direction, and the processing of step S206 and subsequent steps is executed.

### (Step S217)

Next, processing of step S217 and subsequent steps will be described.

In step S213, in a case where the safety of the selected sub-goal is not confirmed, that is, in a case where it is confirmed the possibility that the mobile object 10 collides with or comes into contact with an obstacle in a case where the mobile object 10 travels along a route in which the center of the mobile object 10 passes through the selected sub-goal, the processing proceeds to step S217.

In this case, in step S217, the mobile object 10 first determines whether or not the safety confirmation for all the set sub-goals is ended.

In a case where the safety confirmation for all the set sub-goals is not ended, the processing returns to step S211, one sub-goal of which the safety has not been confirmed is selected, and the safety confirmation processing is executed for the selected sub-goal in step S212 and subsequent steps.

In a case where it is determined in step S217 that the safety confirmation for all the set sub-goals is ended, the processing proceeds to step S218.

### (Step S218)

The processing of step S218 is processing executed in a case where it is determined in step S217 that the safety confirmation for all the set sub-goals is ended.

In this case, in step S218, the mobile object 10 determines whether or not the sub-goal setting mode is the “second sub-goal pattern (dense sub-goal pattern) generation mode”.

In a case where it is determined that the sub-goal setting mode is the “second sub-goal pattern (dense sub-goal pattern) generation mode”, the processing proceeds to step S221.

On the other hand, in a case where it is determined that the sub-goal setting mode is not the “second sub-goal pattern (dense sub-goal pattern) generation mode”, the processing proceeds to step S219.

(Step S219) The processing of step S219 is processing executed in a case where it is determined in step S218 that the sub-goal setting mode is not the “second sub-goal pattern (dense sub-goal pattern) generation mode”.

That is, in a case where it is determined in step S217 that the safety confirmation processing for the sub-goal of all of the set sub-goals is ended and it is determined in step S218 that the sub-goal setting mode is the “first sub-goal pattern (coarse sub-goal pattern) generation mode”, the processing of step S219 is executed.

In this case, in step S219, the data processing unit of the mobile object 10 sets the sub-goal generation mode to the “second sub-goal pattern (dense sub-goal pattern) generation mode”.

That is, for example, the sub-goal generation mode is set to a generation mode of the pattern described above with reference to FIG. 11(B), that is, the “(B) second sub-goal pattern (dense sub-goal pattern)”.

The “(B) second sub-goal pattern (dense sub-goal pattern)” is a pattern in which the interval between individual sub-goals is narrow, that is, a sub-goal pattern in which the distance between adjacent sub-goals is small.

### (Step S220)

Next, in step S220, the data processing unit of the mobile object 10 generates sub-goals (dense sub-goals) according to the second sub-goal pattern (dense sub-goal pattern).

That is, the mobile object 10 sets a dense sub-goal pattern in which the interval between individual sub-goals is narrow, at the position separated by a certain distance in the traveling direction of the mobile object 10.

Specifically, for example, a dense sub-goal pattern according to the “(B) second sub-goal pattern (dense sub-goal pattern)” described above with reference to FIG. 11 is generated.

After processing of setting the dense sub-goal pattern in step S220, the processing returns to step S211.

In step S211, one sub-goal as the safety confirmation processing target is selected from the dense sub-goal pattern.

The selection processing is executed as processing of sequentially selecting the sub-goals in the order of proximity from the user set route.

Thereafter, in step S212 and subsequent steps, the safety confirmation processing is executed for the sub-goal selected from the dense sub-goal pattern.

In a case where the sub-goal of which the safety has been confirmed is detected from the dense sub-goal pattern (Yes in step S213), a new traveling route passing through the sub-goal is set and the mobile object travels in step S214, and the processing of step ZS215 and subsequent steps is executed.

Note that, in a case where the sub-goal of which the safety has been confirmed is not detected from the dense sub-goal pattern (No in step S213), it is determined in step S217 whether or not the safety confirmation for all the set dense sub-goal pattern is ended.

In a case where the safety confirmation for all the set dense sub-goal pattern is not ended, the processing returns to step S211, one sub-goal of which the safety has not been confirmed is selected, and the safety confirmation processing is executed for the selected sub-goal in step S212 and subsequent steps.

In a case where it is determined in step S217 that the safety confirmation for all the set dense sub-goal pattern is ended, the processing proceeds to step S218.

In a case where it is determined in step S218 that the sub-goal setting mode is the “second sub-goal pattern (dense sub-goal pattern) generation mode”, the processing proceeds to step S221.

### (Step S221)

The processing of step S221 is executed in a case where it is determined in step S217 that the safety confirmation processing for the sub-goal of all of the set sub-goals is ended and it is determined in step S218 that the sub-goal setting mode is the “second sub-goal pattern (dense sub-goal pattern) generation mode”.

In this case, in step S221, the data processing unit of the mobile object 10 determines that safe traveling of the mobile object 10 is impossible, and executes processing of stopping.

In this manner, the information processing device of the present disclosure, for example, the mobile object 10 first sets a coarse sub-goal pattern according to the “first sub-goal pattern (coarse sub-goal pattern)” at the position separated by a certain distance in the traveling direction of the mobile object 10, and performs the safety evaluation of the route passing through each sub-goal constituting the coarse sub-goal pattern.

In a case where a sub-goal enabling the safe traveling is detected from the sub-goals constituting the coarse sub-goal pattern, a traveling route according to the traveling route passing through the sub-goal is set, and the traveling is performed along the traveling route.

On the other hand, only in a case where the sub-goal enabling the safe traveling cannot be detected from the sub-goals constituting the coarse sub-goal pattern, the dense sub-goal pattern according to the “second sub-goal pattern (dense sub-goal pattern)” is set, and the safety evaluation of the route passing through each sub-goal constituting the dense sub-goal pattern is performed.

In a case where the sub-goal enabling the safe traveling is detected from the sub-goals constituting the dense sub-goal pattern, a traveling route according to the traveling route passing through the sub-goal is set, and the traveling is performed along the traveling route.

In a case where a sub-goal enabling the safe traveling is not detected from the sub-goals constituting the dense sub-goal pattern, the traveling is stopped.

As described above, the information processing device of the present disclosure, for example, the mobile object 10 can reduce the processing load of the safety evaluation processing by first performing the safety evaluation on the coarse sub-goal pattern.

Moreover, only in a case where a sub-goal enabling the safe traveling is not detected by the safety evaluation on the coarse sub-goal pattern, the dense sub-goal pattern is set, and the safety evaluation is executed on each of the dense sub-goal patterns.

This processing enables detailed setting of the traveling route of the mobile object 10, and the detection success rate of the route enabling the safe traveling of the mobile object 10 can be increased.

That is, by performing the traveling control processing of the present disclosure, it is possible to simultaneously realize two effects of reducing the processing load of the safety evaluation processing of the sub-goal and improving the possibility of detecting the safe traveling route of the mobile object.

Note that, in the processing sequence described with reference to FIGS. 13 and 14, the following two types of sub-goal patterns, that is,
the (A) first sub-goal pattern (coarse sub-goal pattern) and
the (B) second sub-goal pattern (dense sub-goal pattern),
these two types of sub-goal patterns are sequentially used to detect a traveling route including the sub-goal enabling the safe traveling.

In the flow described above, in a case where the traveling route including the sub-goal enabling the safe traveling cannot be detected by sequentially using the two types of sub-goal patterns, the mobile object 10 is caused to stop, but moreover, a configuration may be adopted in which processing of detecting the traveling route including the safe sub-goal is executed using third and fourth sub-goal patterns having a sub-goal arrangement configuration different from that of the two types of sub-goal patterns.

### 5. Regarding Example of Setting Sub-Goal Available for Processing of Present Disclosure

Next, an example of setting sub-goals available for the processing of the present disclosure will be described.

The information processing device of the present disclosure, for example, the mobile object 10 generates and uses the sub-goals according to, for example, a plurality of different sub-goal patterns described above with reference to FIG. 11.

The sub-goal patterns described above with reference to FIG. 11 are the following two types of sub-goal patterns.
(A) First sub-goal pattern (coarse sub-goal pattern)
(B) Second sub-goal pattern (dense sub-goal pattern)

The information processing device of the present disclosure, for example, the mobile object 10 first performs the safety verification of the “(A) first sub-goal pattern (coarse sub-goal pattern)”, sets the “(B) second sub-goal pattern (dense sub-goal pattern)” in a case where no sub-goal enabling the safe traveling is found, and executes the safety verification of these sub-goals.

The (A) first sub-goal pattern (coarse sub-goal pattern) illustrated in FIG. 11 is a sub-goal pattern in which five sub-goals (SG1 to SG5) are set on a line separated by a certain distance, in the traveling direction of the mobile object 10.

On the other hand, the (B) second sub-goal pattern (dense sub-goal pattern) is a sub-goal pattern in which 11 sub-goals (SG1 to SG11) are set on a line separated by a certain distance, in the traveling direction of the mobile object 10.

The combination of the (A) first sub-goal pattern (coarse sub-goal pattern) and the (B) second sub-goal pattern (dense sub-goal pattern) can be another combination.

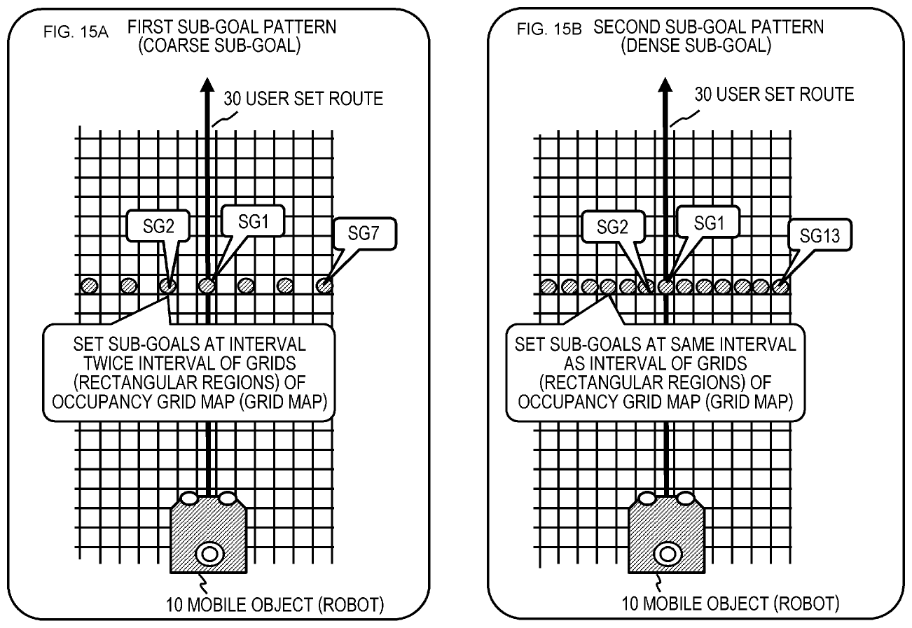

An example is illustrated in FIG. 15.

The (A) first sub-goal pattern (coarse sub-goal pattern) illustrated in FIG. 15 is a sub-goal pattern in which seven sub-goals (SG1 to SG7) are set on a line separated by a certain distance, in the traveling direction of the mobile object 10.

On the other hand, the (B) second sub-goal pattern (dense sub-goal pattern) is a sub-goal pattern in which 13 sub-goals (SG1 to SG13) are set on a line separated by a certain distance, in the traveling direction of the mobile object 10.

In the (A) first sub-goal pattern (coarse sub-goal pattern), sub-goals are set at an interval twice the interval of the grids (rectangular regions) of the occupancy grid map (grid map).

On the other hand, in the (B) second sub-goal pattern (dense sub-goal pattern), sub-goals are set at the same interval as the interval of the grids (rectangular regions) of the occupancy grid map (grid map).

As described above, the occupancy grid map (grid map) is a map in which a probability value of presence of an obstacle in each section (grid) defined by the grid is set.

The mobile object 10 can travel safely without colliding with an obstacle by selecting, as a traveling route, a section (grid) in which the probability of the presence of an obstacle is low, among sections of the occupancy grid map (grid map), and traveling.

The sub-goal pattern illustrated in FIG. 15 has a configuration in which the sub-goals are set with reference to each section (grid) defined by the grid of the occupancy grid map (grid map).

The size of each section (grid) defined by the grid of the occupancy grid map (grid map) is defined according to the resolution of the occupancy grid map (grid map).

That is, the sub-goal pattern illustrated in FIG. 15 is a sub-goal pattern having a sub-goal arrangement configuration according to the resolution of the occupancy grid map (grid map).

Such sub-goal setting may be used.

The mobile object 10 first performs the safety verification on the “(A) first sub-goal pattern (coarse sub-goal pattern)” in which seven sub-goals are set at an interval twice the interval of the grids (rectangular regions) of the occupancy grid map (grid map) illustrated in FIG. 15(A).

In this safety verification processing, in a case where no sub-goal enabling the safe traveling is found, the “(B) second sub-goal pattern (dense sub-goal pattern)” illustrated in FIG. 15(B), that is, the “(B) second sub-goal pattern (dense sub-goal pattern)” in which sub-goals are set at the same interval as the interval of the grids (rectangular regions) of the occupancy grid map (grid map) is set, and the safety verification of these sub-goals is executed.

Such processing may be performed.

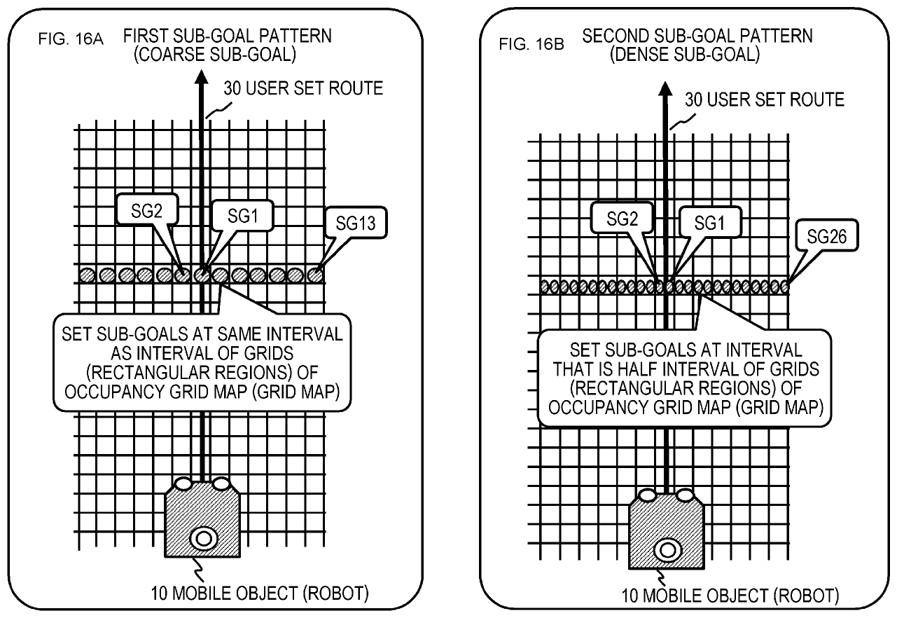

Moreover, another example is illustrated in FIG. 16.

The “(A) first sub-goal pattern (coarse sub-goal pattern)” illustrated in FIG. 16 is a sub-goal pattern in which 13 sub-goals (SG1 to SG13) are set on a line separated by a certain distance, in the traveling direction of the mobile object 10.

On the other hand, the (B) second sub-goal pattern (dense sub-goal pattern) is a sub-goal pattern in which 26 sub-goals (SG1 to SG26) are set on a line separated by a certain distance, in the traveling direction of the mobile object 10.

In the (A) first sub-goal pattern (coarse sub-goal pattern), sub-goals are set at the same interval as the interval of the grids (rectangular regions) of the occupancy grid map (grid map).

On the other hand, in the (B) second sub-goal pattern (dense sub-goal pattern), sub-goals are set at an interval that is half the interval of the grids (rectangular regions) of the occupancy grid map (grid map).

Such sub-goal setting may be used.

The mobile object 10 first performs the safety verification on the “(A) first sub-goal pattern (coarse sub-goal pattern)” in which 13 sub-goals are set at the same interval as the interval of the grids (rectangular regions) of the occupancy grid map (grid map) illustrated in FIG. 16(A).

In this safety verification processing, in a case where no sub-goal enabling the safe traveling is found, the “(B) second sub-goal pattern (dense sub-goal pattern)” illustrated in FIG. 16(B), that is, the “(B) second sub-goal pattern (dense sub-goal pattern)” in which sub-goals are set at an interval that is half the interval of the grids (rectangular regions) of the occupancy grid map (grid map) is set, and the safety verification of these sub-goals is executed.

Such processing may be performed.

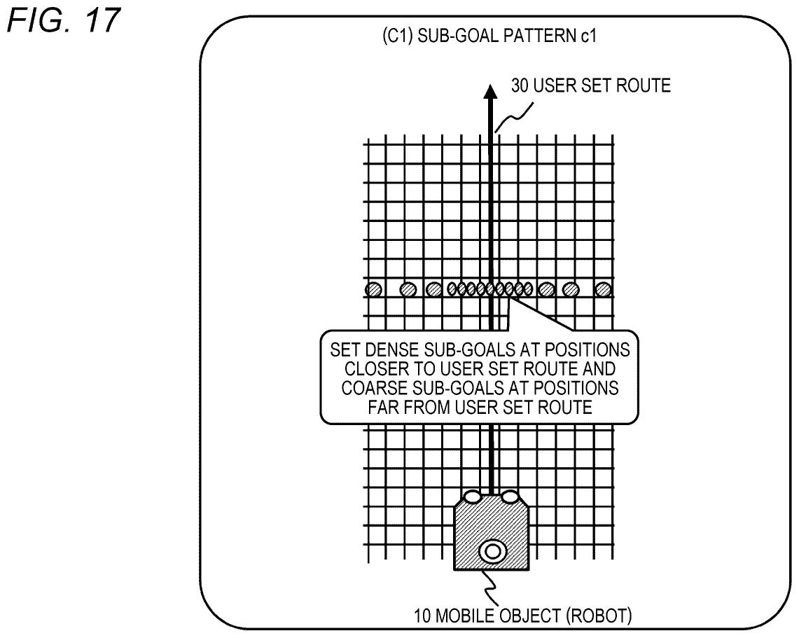

Moreover, as another sub-goal setting example, for example, sub-goal setting as illustrated in FIG. 17 can also be used.

A “(C1) sub-goal pattern c1” illustrated in FIG. 17 is a sub-goal pattern having setting in which the sub-goal interval is small in a region close to the user set route 30 and the sub-goal interval is large in a region far from the user set route 30.

For example, the two sub-goal patterns described above with reference to FIG. 11 are illustrated.
(A) First sub-goal pattern (coarse sub-goal pattern)
(B) Second sub-goal pattern (dense sub-goal pattern)

Instead of the “(B) second sub-goal pattern (dense sub-goal pattern)” in these sub-goal patterns, the setting in which the “(C1) sub-goal pattern c1” illustrated in FIG. 17 is used is possible.

Alternatively, a configuration may be adopted in which a sub-goal pattern in which the average sub-goal interval of the “(C1) sub-goal pattern c1” illustrated in FIG. 17 is wide and a sub-goal pattern in which the average sub-goal interval thereof is narrow are generated and used.

In the case of this setting, the mobile object 10 first executes the safety verification using “the sub-goal pattern in which the average sub-goal interval is wide” in advance. In a case where a sub-goal enabling the safe traveling cannot be detected in this safety verification, next, processing of executing the safety verification using “the sub-goal pattern in which the average sub-goal interval is narrow” is performed.

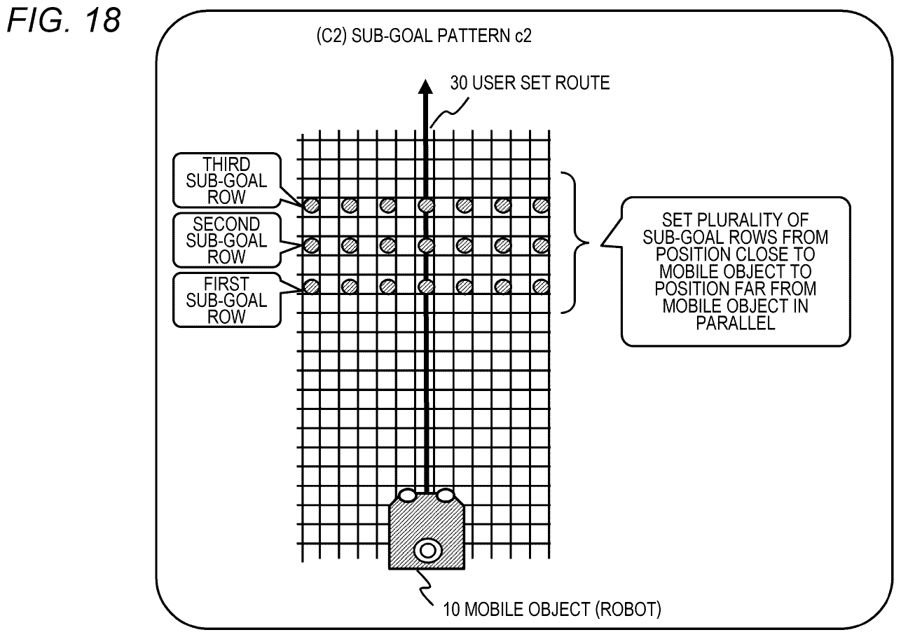

Moreover, as another sub-goal setting example, for example, sub-goal setting as illustrated in FIG. 18 can also be used.

A “(C2) sub-goal pattern c2” illustrated in FIG. 18 is an example in which a plurality of sub-goal rows (first sub-goal row to third sub-goal row) is set in parallel from a position close to the mobile object 10 to a position far from the mobile object 10.

In a case where such a plurality of sub-goal rows is set, the mobile object 10 executes the safety verification of each sub-goal according to a predefined sequence.

For example, for the first sub-goal row closest to the mobile object 10, the safety verification is performed in order from the sub-goal close to the user set route 30.

Here, in a case where a safe sub-goal is detected, next, the safety verification is performed for each sub-goal in the sub-goal row 2.

Here, in a case where a safe sub-goal is detected, next, the safety verification is performed for each sub-goal in the sub-goal row 3.

In a case where sub-goal of which the safety has been confirmed is detected from all the sub-goal rows, a route connecting the sub-goals is set as the traveling route and the traveling is performed.

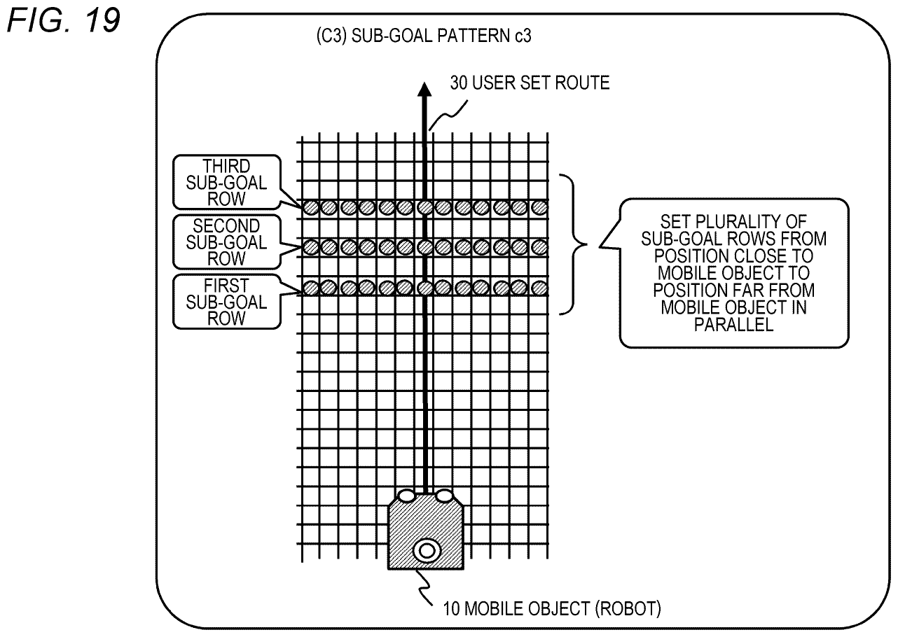

In a case where the sub-goal of which the safety has been confirmed is not detected from all the sub-goal rows, the safety verification is further executed using, for example, a “(C3) sub-goal pattern c3” illustrated in FIG. 19.

The “(C3) sub-goal pattern c3” illustrated in FIG. 19 is a sub-goal pattern in which the sub-goal interval is densely set in each sub-goal row. The safety verification is executed using the “(C3) sub-goal pattern c3”.

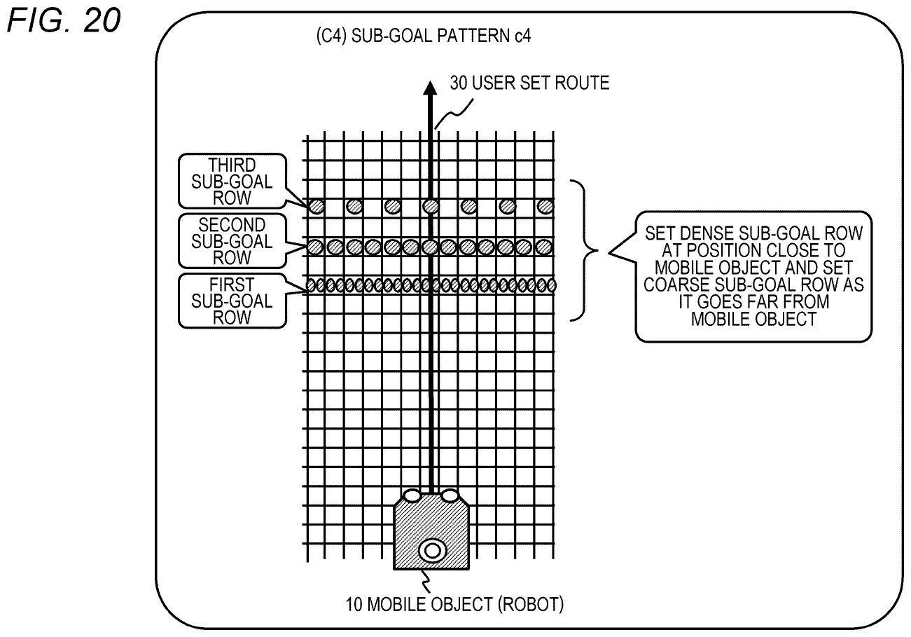

Moreover, as an example of the sub-goal pattern in which a plurality of sub-goal rows is set, the sub-goal setting having setting as illustrated in FIG. 20 may be used.

In a “(C4) sub-goal pattern c4” illustrated in FIG. 20, similarly to the examples illustrated in FIGS. 18 and 19, a plurality of sub-goal rows (first sub-goal row to third sub-goal row) is set in parallel from the position close to the mobile object 10 to the position far from the mobile object 10, but the sub-goal row close to the mobile object 10 is a row with a dense sub-goal pattern in which the sub-goal interval is narrow. The setting in which the sub-goal interval is wider as the distance from the mobile object 10 is increased is made.

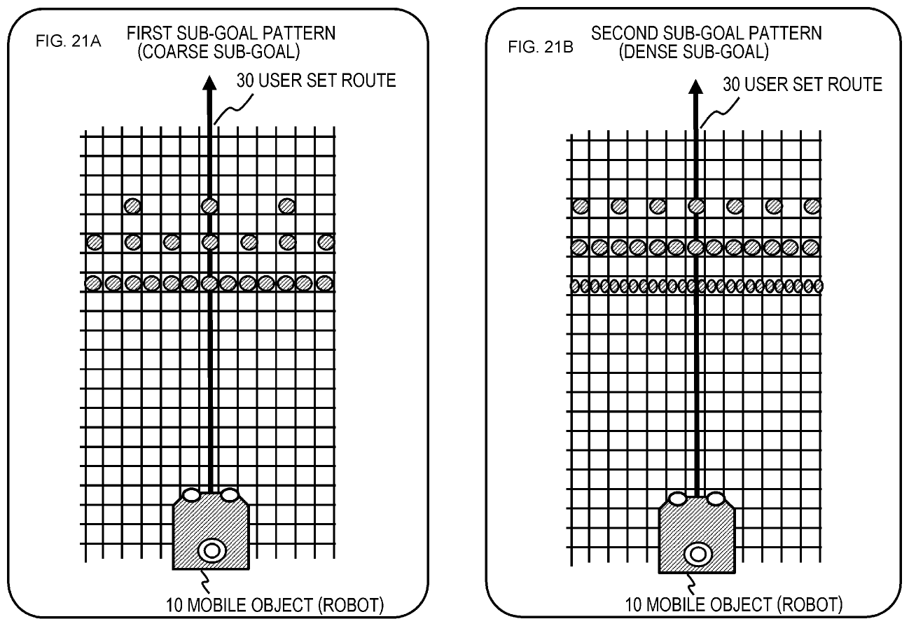

A configuration may be adopted in which the safety verification is performed on a sub-goal basis using such a sub-goal pattern. In a case where two-stage safety verification of the coarse sub-goal pattern and the dense sub-goal pattern is performed, for example, process using two sub-goal patterns having different densities as illustrated in FIG. 21 is executed.

FIG. 21 illustrates the following two sub-goal patterns having different densities including a plurality of sub-goal rows similar to the “(C4) sub-goal pattern c4” illustrated in FIG. 20.
(A) First sub-goal pattern (coarse sub-goal pattern)
(B) Second sub-goal pattern (dense sub-goal pattern)

The information processing device of the present disclosure, for example, the mobile object 10 first performs the safety verification of the “(A) first sub-goal pattern (coarse sub-goal pattern)”, sets the “(B) second sub-goal pattern (dense sub-goal pattern)” in a case where no sub-goal enabling the safe traveling is found, and executes the safety verification of these sub-goals.

As described above, the sub-goal patterns with various settings can be used in the processing of the present disclosure.

### 6. Regarding User Interface Enabling Processing Such as Sub-Goal Setting

Next, the user interface enabling processing such as sub-goal setting will be described.

As described above, in the traveling control of the mobile object of the present disclosure, the safety verification is executed on a sub-goal basis in order to determine a safe traveling route of the mobile object, and various patterns can be used as the sub-goal pattern.

Hereinafter, the user interface enabling processing such as sub-goal setting will be described.

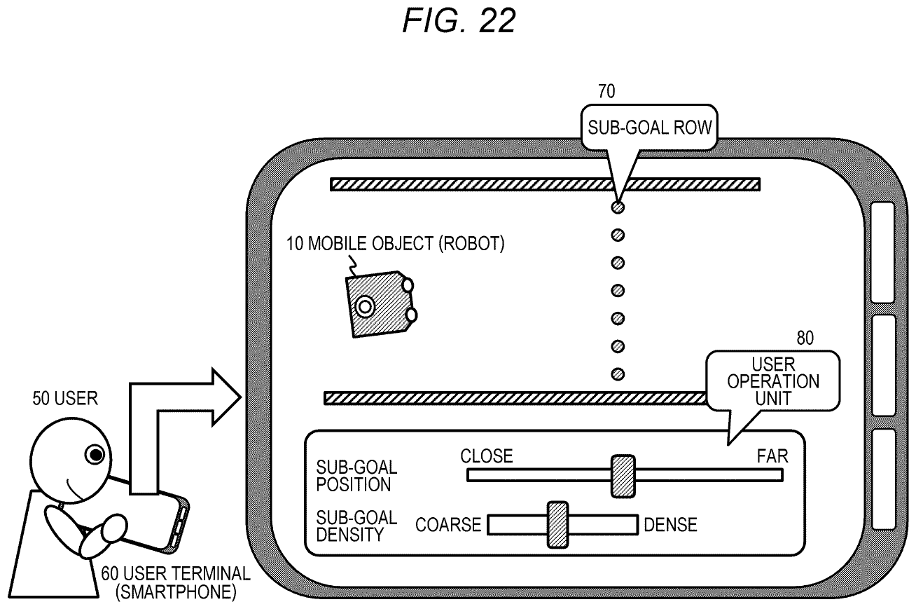

FIG. 22 is a diagram illustrating an example of setting sub-goals using a user terminal 60 capable of communicating with the mobile object 10.

A user 50 sets sub-goals using the user terminal 60 such as a smartphone, and transmits sub-goal setting information to the mobile object 10.

As illustrated in FIG. 22, on the user terminal 60, a sub-goal row 70 to be set on the traveling route of the mobile object 10 and a user operation unit 80 are displayed.

In the user operation unit 80, a sub-goal position adjustment unit and a sub-goal density adjustment unit are displayed.

The sub-goal position adjustment unit is an adjustment unit that can adjust the distance between the sub-goal row 70 and the mobile object 10, and can move the sub-goal row 70 from a position close to the mobile object 10 to a position far from the mobile object 10 by moving the slider.

The sub-goal density adjustment unit is an adjustment unit that can adjust the density of the sub-goals set in the sub-goal row 70, and can set sub-goals with various densities from a coarse sub-goal pattern to a dense sub-goal pattern by adjusting the sub-goal interval set in the sub-goal row 70 by moving the slider.

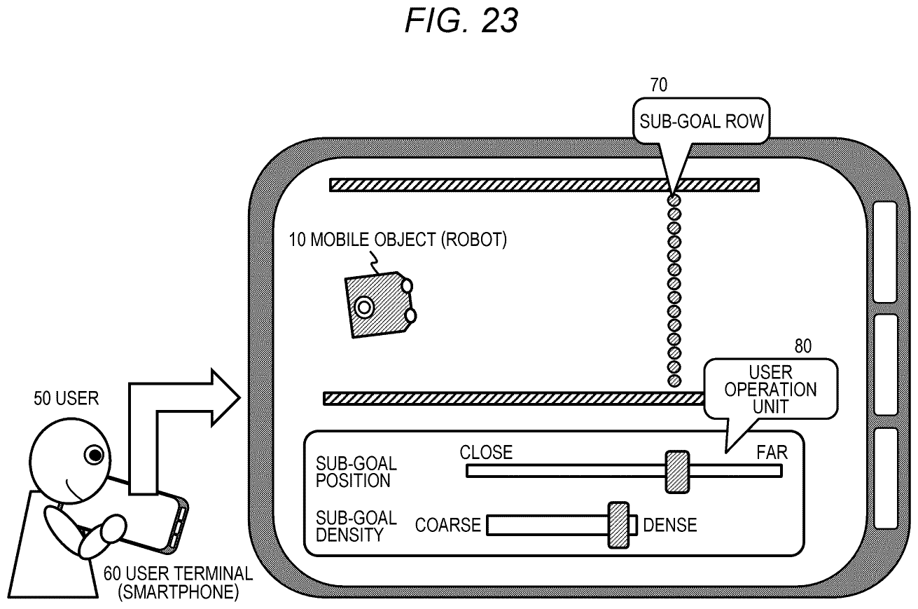

FIG. 23 illustrates an example of a case where a dense sub-goal pattern is set by moving the slider of the sub-goal density adjustment unit.

As illustrated in FIG. 23, the user 50 can set a dense sub-goal pattern in which the interval of the sub-goals set in the sub-goal row 70 is narrow, by moving the slider of the sub-goal density adjustment unit of the user operation unit 80 to the “dense” side.

These pieces of sub-goal setting information are transmitted to the mobile object 10 via the user terminal 60.

The mobile object 10 sets sub-goals according to the sub-goal setting information received from the user terminal 60.

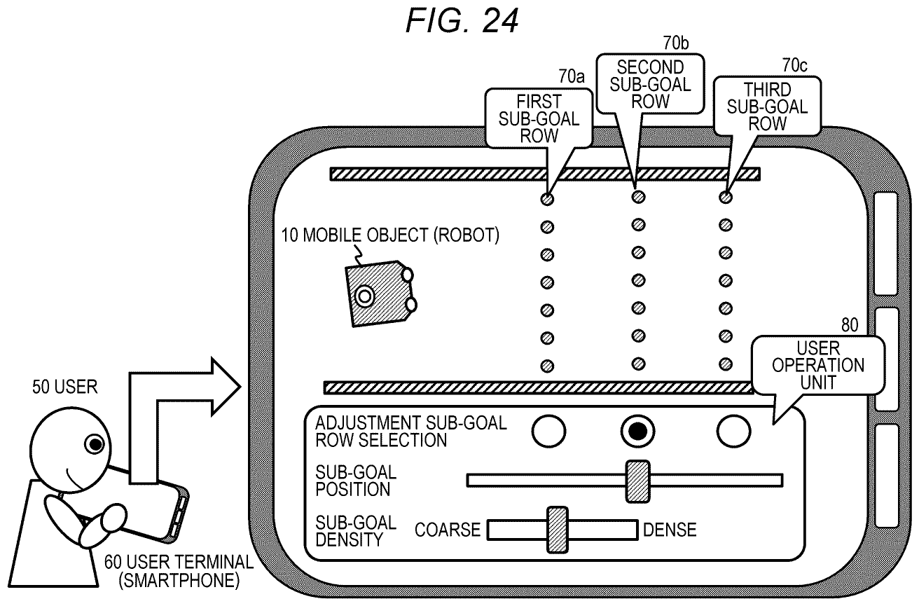

FIG. 24 is a diagram illustrating a sub-goal adjustment example in a case where a plurality of sub-goal rows (first sub-goal row 70a to third sub-goal row 70c) is set.

First, the user 50 selects one sub-goal row as an adjustment target from the adjustment sub-goal row selection part of the user operation unit 80.

Thereafter, for the selected sub-goal row, the position and the density of the sub-goal can be adjusted by moving the sliders of the sub-goal position adjustment unit and the sub-goal density adjustment unit.

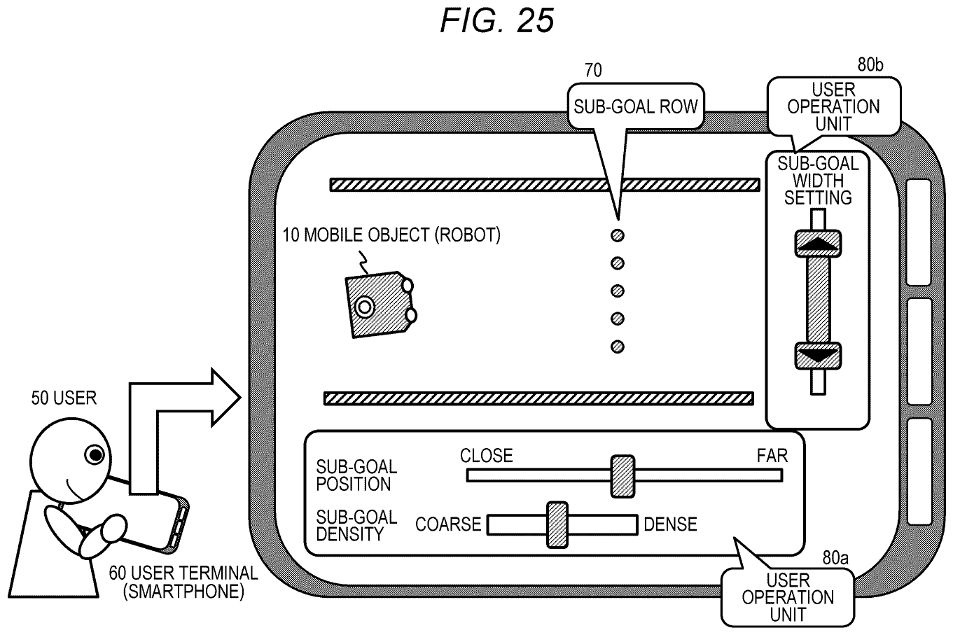

FIG. 25 illustrates an example in which a user operation unit 80b capable of adjusting the setting width of the sub-goal row 70 is provided.

The user 50 can adjust the positions of the upper end and the lower end of the sub-goal by vertically operating the two upper and lower sliders of the sub-goal width setting part of the user operation unit 80b.

Note that the sub-goal adjustment examples described with reference to FIGS. 22 to 25 are adjustment examples using the user terminal 60 such as a smartphone capable of communicating with the mobile object 10, but for example, a configuration may be adopted in which the user directly performs an input to adjust the sub-goal setting via a user interface (UI) unit provided in the mobile object 10.

### 7. Regarding Configuration Example of Information Processing Device

Next, a configuration example of the information processing device of the present disclosure will be described.

As described above, for example, it is configured inside the mobile object 10. Note that the data processing unit other than the sensor unit and the drive unit may be provided in an external device such as a server that can communicate with the mobile object 10.

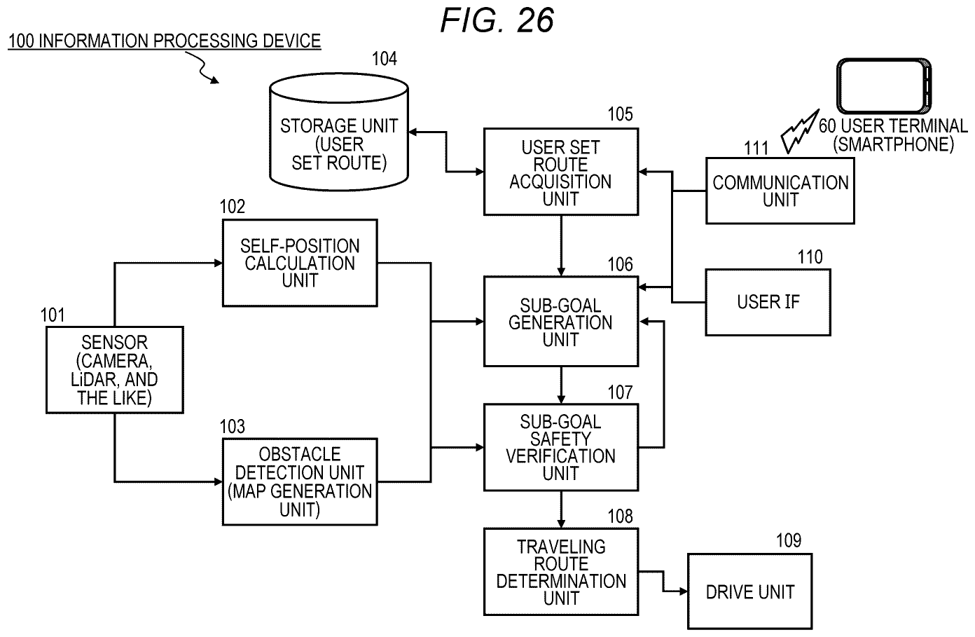

FIG. 26 is a block diagram showing a configuration example of an information processing device 100 of the present disclosure.

Note that the information processing device 100 illustrated in FIG. 26 is a device provided inside the mobile object 10.

As illustrated in FIG. 26, the information processing device 100 includes a sensor (camera, LiDAR, and the like) 101, a self-position calculation unit 102, an obstacle detection unit (map generation unit) 103, a storage unit 104, a user set route acquisition unit 105, a sub-goal generation unit 106, a sub-goal safety verification unit 107, a traveling route determination unit 108, a drive unit 109, a user IF 110, and a communication unit 111.

Details of each component of the information processing device 100 and processing to be executed will be sequentially described.

The sensor 101 is a sensor including, for example, a camera, LiDAR, and the like, and is a sensor that acquires an image for analyzing an external environment of the mobile object 10, distance information to various objects such as obstacles, and the like.

Note that light detection and ranging (LiDAR) is a sensor that includes an input and output unit of laser light, and measures a distance to an obstacle using the laser light.

Note that the sensor 101 is not limited to the camera and the LiDAR, and may include other sensors. For example, a configuration may be adopted in which a ToF sensor, an ultrasonic sensor, a radar, a sonar, and the like are provided.

The self-position calculation unit 102 performs, for example, the self-position estimation processing based on the acquired information of the sensor 101. For example, self-position estimation or the like to which simultaneous localization and mapping (SLAM) processing described above is applied is performed.

As described above, the SLAM processing is processing of estimating a three-dimensional position of the feature point by capturing an image (moving image) with a camera and analyzing the trajectory of the feature point included in a plurality of captured images, and of estimating (localization) the position and orientation of the camera (self), and the SLAM processing is capable of creating (mapping) a surrounding map (environmental map) by using the three-dimensional position information of the feature point.

For example, the obstacle detection unit (map generation unit) 103 detects various obstacles in the traveling environment of the mobile object 10 on the basis of the acquired information of the sensor 101, and generates a map having arrangement information of the obstacles. This processing can also be executed by applying the SLAM processing described above, for example.

The storage unit 104 stores, for example, the traveling route information (user set route) of the mobile object set in advance by the user (operator). This is the user set route 30 described in the embodiment described above.

The user set route acquisition unit 105 acquires the user set route stored in the storage unit 104, and outputs the user set route to the sub-goal generation unit 106.

Note that the user set route may be input from the user interface (IF) 110. Furthermore, the input may be performed from an external terminal, for example, the user terminal 60 such as a smartphone, via the communication unit 111. Alternatively, it may be input from an external server.

In a case where the user set route is input from the outside, the user set route acquisition unit 105 outputs the input user set route to the sub-goal generation unit 106, and further stores the user set route in the storage unit 104.

The sub-goal generation unit 106 generates sub-goals in the vicinity of the user set route input from the user set route acquisition unit 105.

For example, a sub-goal pattern including sub-goal rows in which a plurality of sub-goals is arranged on lines substantially orthogonal to the user set route set in advance, that is, a sub-goal pattern in which a plurality of sub-goals is arranged from a position near the user set route to a position far from the user set route is generated.

Note that the sub-goal generation processing by the sub-goal generation unit 106 is executed according to the processing sequence of the flowcharts illustrated in FIGS. 13 and 14 described above.

That is, first, the sub-goals (coarse sub-goals) are generated according to the first sub-goal pattern (coarse sub-goal pattern).

In the safety verification processing of the sub-goals with the coarse sub-goal pattern, in a case where the sub-goal enabling the safe traveling without coming into contact with an obstacle is not detected, the sub-goals (dense sub-goals) according to the second sub-goal pattern (dense sub-goal pattern) are generated.

Note that, as described above with reference to FIG. 11 and FIGS. 15 to 21, there are many patterns of sub-goals. The sub-goal pattern to be used can be set by the user using, for example, the user terminal 60. Alternatively, the user can perform an input via the user IF 110.

The sub-goal setting information set by the user using the user terminal 60 is input to the sub-goal generation unit 106 via the communication unit 111. The sub-goal setting information set by the user via the user IF 110 is also input to the sub-goal generation unit 106.

The sub-goal generation unit 106 generates the sub-goal pattern according to the user setting on the basis of the input information.

Note that, in a case where no user input is performed, predefined default sub-goal patterns, for example, the following two sub-goal patterns described above with reference to FIG. 11 are sequentially generated.
(A) First sub-goal pattern (coarse sub-goal pattern)
(B) Second sub-goal pattern (dense sub-goal pattern)

The sub-goal safety verification unit 107 verifies the safety of each of the sub-goals generated by the sub-goal generation unit 106.

The safety verification processing of each of the sub-goals by the sub-goal safety verification unit 107 is executed according to the processing sequence of the flowcharts illustrated in FIGS. 13 and 14 described above.

That is, first, the sub-goal is selected in the order from the position closer to the user set route 30, from the first sub-goal pattern (coarse sub-goal pattern) generated by the sub-goal generation unit 106, and the safety thereof is verified.

The safety verification processing of the sub-goal by the sub-goal safety verification unit 107 is executed as follows, for example.

It is verified whether or not the mobile object 10 collides with or comes into contact with an obstacle, for example, in a case where the mobile object 10 travels on a route in which the center of the mobile object 10 passes through the selected sub-goal position, by using the obstacle position analyzed by the obstacle detection unit (map generation unit) 103 using the sensor detection information of the sensor (camera, LiDAR, and the like) 101 and the self-position information calculated by the self-position calculation unit 102.

In the sub-goal safety verification unit 107, in a case where the sub-goal enabling the safe traveling is not detected from the first sub-goal pattern (coarse sub-goal pattern) generated by the sub-goal generation unit 106, the second sub-goal pattern (dense sub-goal pattern) generated by the sub-goal generation unit 106 is input next.

The sub-goal safety verification unit 107 verifies whether or not the safe traveling is possible for each of the sub-goals constituting the second sub-goal pattern (dense sub-goal pattern).

In the sub-goal safety verification unit 107, in a case where the sub-goal enabling the safe traveling is detected, the position information of the sub-goal enabling the safe traveling is output to the traveling route determination unit 108.

The traveling route determination unit 108 uses the sub-goal position information input from the sub-goal safety verification unit 107, that is, the position information of the sub-goal enabling the safe traveling to generate a traveling route passing through the sub-goal, and outputs a drive command for causing the mobile object 10 to travel along the generated traveling route, to the drive unit 109.

The drive unit 109 generates control information for driving the mobile object 10 along the traveling route input from the traveling route determination unit 1108, controls the mobile object 10, and causes the mobile object 10 to travel along the determined traveling route.

By performing such processing, it is possible for the mobile object 10 to safely travel a position close to the user set route 30 set in advance without colliding with or coming into contact with an obstacle.

### 8. Regarding Configuration Example of Information Processing System that Performs Processing by Executing Communication Between Mobile Object and Server

Next, the configuration example of the information processing system that performs processing by executing communication between the mobile object and the server will be described.

In the above-described embodiment, the configuration has been described in which the information processing device performing the above-described processing is mounted in the mobile object 10 that performs self-position estimation and obstacle detection by, for example, SLAM processing or the like, but, as described above, the information processing device of the present disclosure may be installed in a server and the like that can communicate with the mobile object 10.

For example, a configuration may be adopted in which sensors for acquiring information around the mobile object 10 is mounted in the mobile object 10, the sensor acquisition information is transmitted to the server via a communication network, and processing using the sensor acquisition information is performed on the server side according to the above-described embodiment.

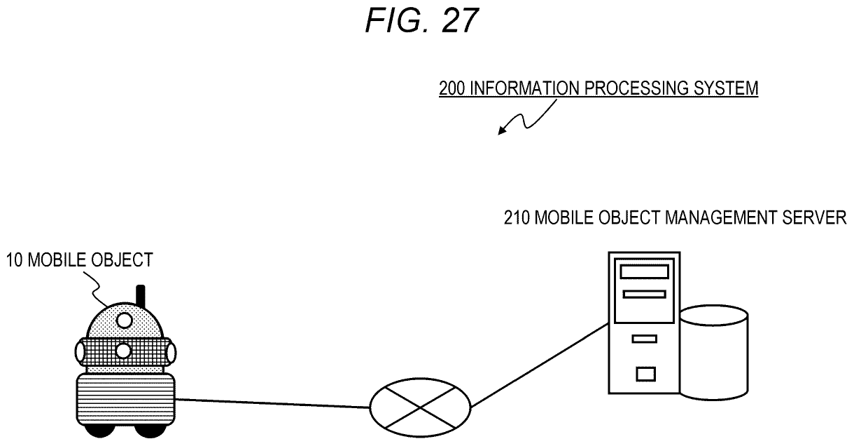

Specifically, as illustrated in FIG. 27, an information processing system 200 in which the mobile object 10 and a mobile object management server 210 are connected via a communication network can be used.

The mobile object 10 transmits the sensor acquisition information to the mobile object management server 210.

The mobile object management server 210 executes data processing according to the above-described embodiment using the sensor acquisition information received from the mobile object 10.

Such an information processing system 200 may be used.

Note that the sensor of the mobile object 10 includes the camera, LiDAR, and the like described in the above-described embodiment.

Moreover, a configuration may be adopted in which a user terminal such as a smartphone is set to be communicable with the mobile object 10 and the mobile object management server 210, and the input information from the user terminal is provided to the mobile object 10 and the mobile object management server 210.

### 9. Regarding Hardware Configuration Example of Information Processing Device

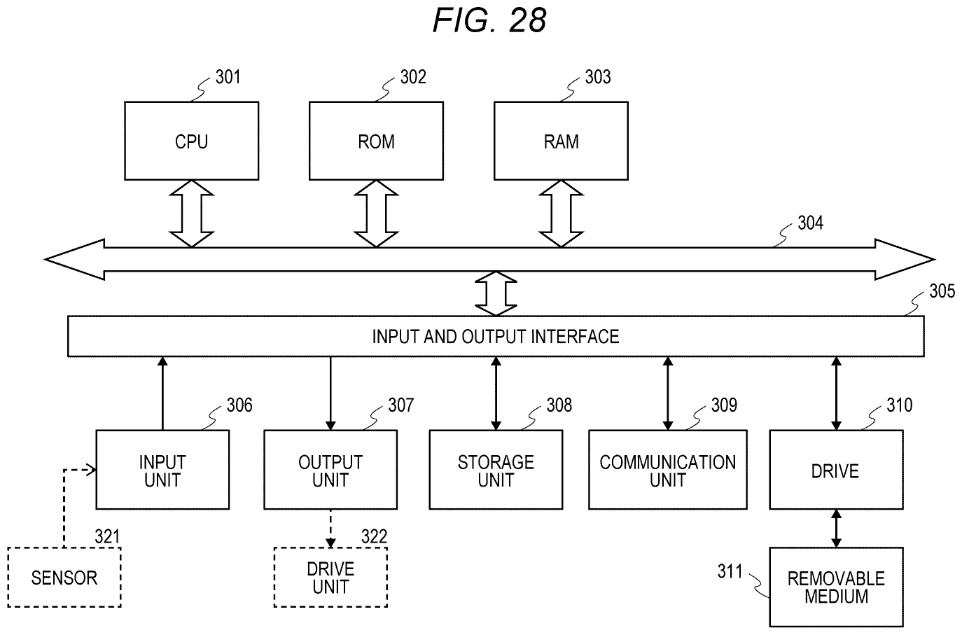

Next, a hardware configuration example of the information processing device of the present disclosure will be described with reference to FIG. 28.

Note that the information processing device is mounted in the mobile object 10. Alternatively, as described above, the data processing unit excluding the sensor unit and the drive unit may be configured in the server.

The hardware configuration illustrated in FIG. 28 is a hardware configuration example applicable to both the information processing device in the mobile object 10 and the information processing device in the server.

The hardware configuration illustrated in FIG. 28 will be described.

A central processing unit (CPU) 301 functions as a data processing unit that executes various kinds of processing according to a program stored in a read only memory (ROM) 302 or a storage unit 308. For example, processing according to the sequence described in the above-described example is performed. A random access memory (RAM) 303 stores programs to be executed by the CPU 301, data, and the like. The CPU 301, the ROM 302, and the RAM 303 are connected to each other by a bus 304.

The CPU 301 is connected to an input and output interface 305 via the bus 304, and to the input and output interface 305, an input unit 306 that includes various switches, a keyboard, a touch panel, a mouse, a microphone, and a status data acquisition unit of a user input unit and various sensors 321 such as a camera and LiDAR, and an output unit 307 that includes a display, a speaker, and the like are connected.

Furthermore, the output unit 307 also outputs drive information for a drive unit 322 of the mobile object (robot).

The CPU 301 inputs commands, status data, and the like inputted from the input unit 306, executes various kinds of processing, and outputs processing results to, for example, the output unit 307.

The storage unit 308 connected to the input and output interface 305 includes, for example, a hard disk, and the like and stores programs executed by the CPU 301 and various kinds of data. A communication unit 309 functions as a transmission and reception unit for data communication via a network such as the Internet or a local area network, and communicates with an external device.

Furthermore, in addition to the CPU, a graphics processing unit (GPU) may be provided as a dedicated processing unit for image information and the like input from the camera.

A drive 310 connected to the input and output interface 305 drives a removable medium 311 such as a magnetic disk, an optical disk, a magneto-optical disk, or a semiconductor memory such as a memory card, and executes data recording or reading.

### 10. Summary of Configuration of Present Disclosure

As described above, the embodiments of the present disclosure have been described in detail with reference to a particular embodiment. However, it is obvious that those skilled in the art can make modifications and substitutions of the embodiment without departing from the gist of the present disclosure. That is, the present invention has been disclosed in a form of exemplification, and should not be interpreted in a limited manner. In order to determine the gist of the present disclosure, the claims should be taken into consideration.

Note that the technology disclosed in this specification can have the following configurations.

(1) An information processing device including:
a sub-goal generation unit that generates a sub-goal pattern including a plurality of sub-goals in a traveling direction of a mobile object; and
a sub-goal safety verification unit that performs safety verification as to whether or not the mobile object can safely travel without colliding with or coming into contact with an obstacle, on each of the sub-goals constituting the sub-goal pattern generated by the sub-goal generation unit,
in which
the sub-goal generation unit generates a first sub-goal pattern and a second sub-goal pattern which have different sub-goal arrangement patterns, and
the sub-goal safety verification unit
   performs the safety verification on each of sub-goals included in the first sub-goal pattern, and
   executes the safety verification on each of sub-goals included in the second sub-goal pattern in a case where the sub-goal enabling safe traveling is not detected from the first sub-goal pattern.

(2) The information processing device described in (1), in which
the sub-goal generation unit
   generates a coarse sub-goal pattern in which an interval between adjacent sub-goals is wide, as the first sub-goal pattern, and
   generates a dense sub-goal pattern in which an interval between adjacent sub-goals is narrow, as the second sub-goal pattern, and
the sub-goal safety verification unit
   performs safety verification on each of the sub-goals included in the coarse sub-goal pattern, and
   executes the safety verification on each of the sub-goals included in the dense sub-goal pattern in a case where the sub-goal enabling the safe traveling is not detected from the coarse sub-goal pattern.

(3) The information processing device described in (1) or (2),
in which the sub-goal generation unit generates a sub-goal pattern in which a plurality of sub-goals is arranged on a line substantially orthogonal to a user set route set in advance.

(4) The information processing device described in any one of (1) to (3), in which
the sub-goal generation unit generates a sub-goal pattern in which a plurality of sub-goals is arranged on a plurality of lines which is substantially orthogonal to a user set route set in advance and has different distances from the mobile object.

(5) The information processing device described in any one of (1) to (4), in which
the sub-goal generation unit generates the second sub-goal pattern as a sub-goal pattern in which the number of sub-goals is larger than the number of sub-goals of the first sub-goal pattern.

(6) The information processing device described in any one of (1) to (5), in which
the sub-goal generation unit arranges the sub-goals of the second sub-goal pattern at different positions from positions of the sub-goals set in the first sub-goal pattern.

(7) The information processing device described in any one of (1) to (6), in which
the sub-goal generation unit generates a sub-goal pattern with a sub-goal arrangement configuration according to a resolution of an occupancy grid map (grid map) used by the mobile object.

(8) The information processing device described in any one of (1) to (7), in which
the sub-goal generation unit generates a sub-goal pattern set such that an interval between adjacent sub-goals is narrow at a position close to a user set route set in advance, and an interval between adjacent sub-goals is wide at a position far from the user set route.

(9) The information processing device described in any one of (1) to (8), in which
the sub-goal safety verification unit sequentially executes the safety verification from the sub-goal at a position near a user set route set in advance.

(10) The information processing device described in any one of (1) to (9), in which
the sub-goal safety verification unit sequentially executes the safety verification from the sub-goal at a position near a user set route set in advance, and in a case where the sub-goal for which safety has been confirmed is detected, the sub-goal safety verification unit does not execute the safety verification on the sub-goal at a position further away from the user set route.

(11) The information processing device described in any one of (1) to (10), in which
in the safety verification in the sub-goal safety verification unit, in a case where the sub-goal enabling the safe traveling is not detected from the first sub-goal pattern and the second sub-goal pattern,
the sub-goal generation unit generates a third sub-goal pattern with a sub-goal arrangement configuration different from sub-goal arrangement configurations of the first sub-goal pattern and the second sub-goal pattern, and
the sub-goal safety verification unit executes the safety verification on each of sub-goals included in the third sub-goal pattern.

(12) The information processing device described in any one of (1) to (11), further including:
a traveling route determination unit that determines a traveling route of the mobile object,
in which
in a case where the sub-goal for which safety has been confirmed is detected, the sub-goal safety verification unit notifies the traveling route determination unit of a position of the sub-goal for which the safety has been confirmed, and
the traveling route determination unit determines a traveling route passing through the position of the sub-goal for which the safety has been confirmed.

(13) The information processing device described in any one of (1) to (12), in which
the sub-goal generation unit inputs sub-goal setting information via a user terminal or a user interface, and generates a sub-goal pattern with a sub-goal arrangement according to the input sub-goal setting information.

(14) An information processing method executed in an information processing device, the information processing method including:
a sub-goal generation step of generating a sub-goal pattern including a plurality of sub-goals in a traveling direction of a mobile object by a sub-goal generation unit; and
a sub-goal safety verification step of performing safety verification as to whether or not the mobile object can safely travel without colliding with or coming into contact with an obstacle, on each of the sub-goals constituting the sub-goal pattern generated by the sub-goal generation unit, by a sub-goal safety verification unit,
in which
the sub-goal generation step is a step of generating a first sub-goal pattern and a second sub-goal pattern which have different sub-goal arrangement patterns, and
the sub-goal safety verification step is a step of
   performing the safety verification on each of sub-goals included in the first sub-goal pattern, and
   executing the safety verification on each of sub-goals included in the second sub-goal pattern in a case where the sub-goal enabling safe traveling is not detected from the first sub-goal pattern.

(15) A program causing an information processing device to execute information processing, the program causing:
a sub-goal generation unit to execute a sub-goal generation step of generating a sub-goal pattern including a plurality of sub-goals in a traveling direction of a mobile object; and
a sub-goal safety verification unit to execute a sub-goal safety verification step of performing safety verification as to whether or not the mobile object can safely travel without colliding with or coming into contact with an obstacle, on each of the sub-goals constituting the sub-goal pattern generated by the sub-goal generation unit,
in which
in the sub-goal generation step,
a first sub-goal pattern and a second sub-goal pattern which have different sub-goal arrangement patterns are generated, and
in the sub-goal safety verification step,
the safety verification is executed on each of sub-goals included in the first sub-goal pattern, and
the safety verification is executed on each of sub-goals included in the second sub-goal pattern in a case where the sub-goal enabling safe traveling is not detected from the first sub-goal pattern.

Note that a series of processes described in the description can be executed by hardware, software, or a combined configuration of both. In a case where processing by software is executed, a program in which a processing sequence is recorded can be installed and executed in a memory in a computer incorporated in dedicated hardware, or the program can be installed and executed in a general-purpose computer capable of executing various kinds of processing. For example, the program can be recorded in advance in a recording medium. In addition to being installed on a computer from a recording medium, the program can be received via a network such as a local area network (LAN) or the Internet and installed on a recording medium such as an internal hard disk or the like.

Furthermore, the various kinds of processing described in the specification are not only executed in time series according to the description, but may be executed in parallel or individually according to the processing capability of the device that executes the processing or as necessary. Furthermore, in the present specification, a system is a logical set configuration of a plurality of devices, and is not limited to a system in which devices of configurations are in the same housing.

### INDUSTRIAL APPLICABILITY

As described above, with the configuration of the embodiment of the present disclosure, a device and a method capable of reducing the processing load in the safety confirmation of the sub-goal and improving the possibility of detecting the safe traveling route are realized.

Specifically, for example, a sub-goal generation unit that generates a sub-goal pattern including a plurality of sub-goals in the traveling direction of the mobile object, and a sub-goal safety verification unit that performs the safety verification on each of the sub-goals constituting the sub-goal pattern as to whether or not the mobile object can safely travel are included. The sub-goal generation unit generates a coarse sub-goal pattern having a wide sub-goal interval and a dense sub-goal pattern having a narrow sub-goal interval. The sub-goal safety verification unit performs the safety verification on the sub-goals of the coarse sub-goal pattern, and in a case where the sub-goal enabling the safe traveling is not detected, the sub-goal safety verification unit executes the safety verification on each of the sub-goals of the dense sub-goal pattern.

With the present configuration, a device and a method capable of reducing the processing load in the safety confirmation of the sub-goal and improving the possibility of detecting the safe traveling route are realized.

### REFERENCE SIGNS LIST

10 Mobile object
11 Another mobile object
20, 21 Obstacle
30 User set route
50 User
60 User terminal
70 Sub-goal row
80 User operation unit
100 Information processing device
101 Sensor (camera, LiDAR, and the like)
102 Self-position calculation unit
103 Obstacle detection unit (map generation unit)
104 Storage unit
105 User set route acquisition unit
106 Sub-goal generation unit
107 Sub-goal safety verification unit
108 Traveling route determination unit
109 Drive unit
110 User IF
111 Communication unit
200 Information processing system
210 Mobile object management server
301 CPU
302 ROM
303 RAM
304 Bus
305 Input and output interface
306 Input unit
307 Output unit
308 Storage unit
309 Communication unit
310 Drive
311 Removable medium
321 Sensor
322 Drive unit

1. An information processing device comprising:
a sub-goal generation unit that generates a sub-goal pattern including a plurality of sub-goals in a traveling direction of a mobile object; and
a sub-goal safety verification unit that performs safety verification as to whether or not the mobile object can safely travel without colliding with or coming into contact with an obstacle, on each of the sub-goals constituting the sub-goal pattern generated by the sub-goal generation unit,
wherein
the sub-goal generation unit generates a first sub-goal pattern and a second sub-goal pattern which have different sub-goal arrangement patterns, and
the sub-goal safety verification unit
performs the safety verification on each of sub-goals included in the first sub-goal pattern, and
executes the safety verification on each of sub-goals included in the second sub-goal pattern in a case where the sub-goal enabling safe traveling is not detected from the first sub-goal pattern.

2. The information processing device according to claim 1, wherein
the sub-goal generation unit
generates a coarse sub-goal pattern in which an interval between adjacent sub-goals is wide, as the first sub-goal pattern, and
generates a dense sub-goal pattern in which an interval between adjacent sub-goals is narrow, as the second sub-goal pattern, and
the sub-goal safety verification unit
performs safety verification on each of the sub-goals included in the coarse sub-goal pattern, and
executes the safety verification on each of the sub-goals included in the dense sub-goal pattern in a case where the sub-goal enabling the safe traveling is not detected from the coarse sub-goal pattern.

3. The information processing device according to claim 1, wherein
the sub-goal generation unit generates a sub-goal pattern in which a plurality of sub-goals is arranged on a line substantially orthogonal to a user set route set in advance.

4. The information processing device according to claim 1, wherein
the sub-goal generation unit generates a sub-goal pattern in which a plurality of sub-goals is arranged on a plurality of lines which is substantially orthogonal to a user set route set in advance and has different distances from the mobile object.

5. The information processing device according to claim 1, wherein
the sub-goal generation unit generates the second sub-goal pattern as a sub-goal pattern in which the number of sub-goals is larger than the number of sub-goals of the first sub-goal pattern.

6. The information processing device according to claim 1, wherein
the sub-goal generation unit arranges the sub-goals of the second sub-goal pattern at different positions from positions of the sub-goals set in the first sub-goal pattern.

7. The information processing device according to claim 1,
wherein the sub-goal generation unit generates a sub-goal pattern with a sub-goal arrangement configuration according to a resolution of an occupancy grid map (grid map) used by the mobile object.

8. The information processing device according to claim 1, wherein
the sub-goal generation unit generates a sub-goal pattern set such that an interval between adjacent sub-goals is narrow at a position close to a user set route set in advance, and an interval between adjacent sub-goals is wide at a position far from the user set route.

9. The information processing device according to claim 1, wherein
the sub-goal safety verification unit sequentially executes the safety verification from the sub-goal at a position near a user set route set in advance.

10. The information processing device according to claim 1, wherein
the sub-goal safety verification unit sequentially executes the safety verification from the sub-goal at a position near a user set route set in advance, and in a case where the sub-goal for which safety has been confirmed is detected, the sub-goal safety verification unit does not execute the safety verification on the sub-goal at a position further away from the user set route.

11. The information processing device according to claim 1, wherein
in the safety verification in the sub-goal safety verification unit, in a case where the sub-goal enabling the safe traveling is not detected from the first sub-goal pattern and the second sub-goal pattern,
the sub-goal generation unit generates a third sub-goal pattern with a sub-goal arrangement configuration different from sub-goal arrangement configurations of the first sub-goal pattern and the second sub-goal pattern, and
the sub-goal safety verification unit executes the safety verification on each of sub-goals included in the third sub-goal pattern.

12. The information processing device according to claim 1, further comprising:
a traveling route determination unit that determines a traveling route of the mobile object,
wherein
in a case where the sub-goal for which safety has been confirmed is detected, the sub-goal safety verification unit notifies the traveling route determination unit of a position of the sub-goal for which the safety has been confirmed, and
the traveling route determination unit determines a traveling route passing through the position of the sub-goal for which the safety has been confirmed.

13. The information processing device according to claim 1, wherein
the sub-goal generation unit inputs sub-goal setting information via a user terminal or a user interface, and generates a sub-goal pattern with a sub-goal arrangement according to the input sub-goal setting information.

14. An information processing method executed in an information processing device, the information processing method comprising:
a sub-goal generation step of generating a sub-goal pattern including a plurality of sub-goals in a traveling direction of a mobile object by a sub-goal generation unit; and
a sub-goal safety verification step of performing safety verification as to whether or not the mobile object can safely travel without colliding with or coming into contact with an obstacle, on each of the sub-goals constituting the sub-goal pattern generated by the sub-goal generation unit, by a sub-goal safety verification unit,
wherein
the sub-goal generation step is a step of generating a first sub-goal pattern and a second sub-goal pattern which have different sub-goal arrangement patterns, and
the sub-goal safety verification step is a step of
performing the safety verification on each of sub-goals included in the first sub-goal pattern, and
executing the safety verification on each of sub-goals included in the second sub-goal pattern in a case where the sub-goal enabling safe traveling is not detected from the first sub-goal pattern.

15. A program causing an information processing device to execute information processing, the program causing:
a sub-goal generation unit to execute a sub-goal generation step of generating a sub-goal pattern including a plurality of sub-goals in a traveling direction of a mobile object; and
a sub-goal safety verification unit to execute a sub-goal safety verification step of performing safety verification as to whether or not the mobile object can safely travel without colliding with or coming into contact with an obstacle, on each of the sub-goals constituting the sub-goal pattern generated by the sub-goal generation unit,
wherein
in the sub-goal generation step,
a first sub-goal pattern and a second sub-goal pattern which have different sub-goal arrangement patterns are generated, and
in the sub-goal safety verification step,
the safety verification is executed on each of sub-goals included in the first sub-goal pattern, and
the safety verification is executed on each of sub-goals included in the second sub-goal pattern in a case where the sub-goal enabling safe traveling is not detected from the first sub-goal pattern.
